SEQUENCE LISTING (73 sequences)

SEQ ID NO: 1 - protein, 118 aa, Artificial Sequence
  Description of Artificial Sequence Synthetic polypeptide
IRDPNQGGKDITEEIMSGARTASTPTPPQTGGGLEPQANGETPQVAVIVRPDDRSQGAIIADRPGLPGPEHSPSESQPSSPSPTPSPSPVLEPGSEPNLAVLSIPGDTMTTIQMSVEE

SEQ ID NO: 2 - protein, 89 aa, Artificial Sequence
  Description of Artificial Sequence Synthetic polypeptide
ESRPMSYDEKRQLSLDINKLPGEKLGRVVHIIQAREPSLRDSNPEEIEIDFETLKPSTLRELERYVLSCLRKKPRKPYSTYEMRFISWF

SEQ ID NO: 3 - protein, 134 aa, Artificial Sequence
  Description of Artificial Sequence Synthetic polypeptide
RCEGINISGNFYRNKLKYLAFLRKRMNTNPSRGPYHFRAPSRIFWRTVRGMLPHKTKRGQAALDRLKVFDGIPPPYDKKKADGGSCCPQGRASEAYKKVCLSGAPGSRGWLEVPGSDSHPGGEEEACGRTRVTS

SEQ ID NO: 4 - protein, 64 aa, Artificial Sequence
  Description of Artificial Sequence Synthetic polypeptide
ITVTSEVPFSKRYLKYLTKKYLKKNNLRDWLRVVANSKESYELRYFQINQDEEEEESLRPHSSN

SEQ ID NO: 5 - protein, 77 aa, Artificial Sequence
  Description of Artificial Sequence Synthetic polypeptide
PASASILAGVPMYRNEFTAWYRRMSVVYGIGTWSVLGSLLYYSRTMAKSSVDQKDGSASEVPSELSERPSLRPHSSN

SEQ ID NO: 6 - protein, 52 aa, Artificial Sequence
  Description of Artificial Sequence Synthetic polypeptide
RMPKEPLKIPVATSRTQASLGKQKCRRRIMMSLRQRWQMGISWMGRLKPTQW

SEQ ID NO: 7 - protein, 74 aa, Artificial Sequence
  Description of Artificial Sequence Synthetic polypeptide
EGSVYQCCEKGKKQVCSQRIFKWMRWLPLRFPKMSLMNSKRPLQKLISTATDSFVTMNFMSSSRKLICHYQDIK

SEQ ID NO: 8 - protein, 55 aa, Artificial Sequence
  Description of Artificial Sequence Synthetic polypeptide
APRTRTLRARRSPRMEIAQKWMMKTVKEEEWNVWMKCPILKNSLPISKINFIKND

SEQ ID NO: 9 - protein, 92 aa, Artificial Sequence
  Description of Artificial Sequence Synthetic polypeptide
QRSGRDNGDVGAGAPFRLSSTSQPRRIKPIAPPPRAPSPECGAGGGGGGRGGGGGGPGGGGVGGRGGGGGGGGRGAGGGRGAGAGGGRPEAA

SEQ ID NO: 10 - protein, 22 aa, Artificial Sequence
  Description of Artificial Sequence Synthetic peptide
GGGRGAGGGRGAGAGGGRPEAA

SEQ ID NO: 11 - protein, 32 aa, Artificial Sequence
  Description of Artificial Sequence Synthetic polypeptide
GVGGRGGGGGGGGRGAGGGRGAGAGGGRPEAA

SEQ ID NO: 12 - protein, 44 aa, Artificial Sequence
  Description of Artificial Sequence Synthetic polypeptide
ILYPETLLKLLISLRRFWAEMMEFSRYTIMSSENRDNLTSSFPN

SEQ ID NO: 13 - protein, 11 aa, Artificial Sequence
  Description of Artificial Sequence Synthetic peptide
LVSILLTKTIY

SEQ ID NO: 14 - protein, 12 aa, Artificial Sequence
  Description of Artificial Sequence Synthetic peptide
QSQHGGPENFKI

SEQ ID NO: 15 - protein, 36 aa, Artificial Sequence
  Description of Artificial Sequence Synthetic polypeptide
NSLPLFPPQNSMGPDIFCPGPLSLDVESLNAVFIDF

SEQ ID NO: 16 - protein, 22 aa, Artificial Sequence
  Description of Artificial Sequence Synthetic peptide
REMVPRMRRTSRASIHHIKPTE

SEQ ID NO: 17 - protein, 84 aa, Artificial Sequence
  Description of Artificial Sequence Synthetic polypeptide
KAECFKNLIVKKQKSLCSGFKEHLNEASILAQVSVSSSKRVWKSWENLISSFMVWNPAHLIISIPNLEKTSDLSMMSKLAAALE

SEQ ID NO: 18 - protein, 11 aa, Artificial Sequence
  Description of Artificial Sequence Synthetic peptide
NNVSALLGWQK

SEQ ID NO: 19 - protein, 38 aa, Artificial Sequence
  Description of Artificial Sequence Synthetic polypeptide
PFCKFRILSPRCLSDATQWPFKVLFKWDCSSNSFLGPN

SEQ ID NO: 20 - protein, 44 aa, Artificial Sequence
  Description of Artificial Sequence Synthetic polypeptide
PTLFPFLQRETQMSKLILTNALRGLFGYMARSGFCPRKGKGTRG

SEQ ID NO: 21 - protein, 31 aa, Artificial Sequence
  Description of Artificial Sequence Synthetic polypeptide
NSDLPFGSLVLSSLYDSNVYSESPVFLQAHE

SEQ ID NO: 22 - protein, 30 aa, Artificial Sequence
  Description of Artificial Sequence Synthetic polypeptide
QKLCQAKEKGMCMKKLRMLWECQKLYSLGF

SEQ ID NO: 23 - protein, 9 aa, Artificial Sequence
  Description of Artificial Sequence Synthetic peptide
SAAGGGEFD

SEQ ID NO: 24 - protein, 9 aa, Artificial Sequence
  Description of Artificial Sequence Synthetic peptide
ASAGGGEFD

SEQ ID NO: 25 - protein, 9 aa, Artificial Sequence
  Description of Artificial Sequence Synthetic peptide
AASGGGEFD

SEQ ID NO: 26 - protein, 9 aa, Artificial Sequence
  Description of Artificial Sequence Synthetic peptide
GAASGGEFD

SEQ ID NO: 27 - protein, 9 aa, Artificial Sequence
  Description of Artificial Sequence Synthetic peptide
GAAGSGEFD

SEQ ID NO: 28 - protein, 9 aa, Artificial Sequence
  Description of Artificial Sequence Synthetic peptide
GAAGGSEFD

SEQ ID NO: 29 - protein, 9 aa, Artificial Sequence
  Description of Artificial Sequence Synthetic peptide
EAAGGGSFD

SEQ ID NO: 30 - protein, 9 aa, Artificial Sequence
  Description of Artificial Sequence Synthetic peptide
FAAGGGESD

SEQ ID NO: 31 - protein, 9 aa, Artificial Sequence
  Description of Artificial Sequence Synthetic peptide
DAAGGGEFS

SEQ ID NO: 32 - protein, 8 aa, Homo sapiens
AIYAAPFK

SEQ ID NO: 33 - protein, 8 aa, Artificial Sequence
  Description of Artificial Sequence Synthetic peptide
ARYAAPDK

SEQ ID NO: 34 - protein, 8 aa, Artificial Sequence
  Description of Artificial Sequence Synthetic peptide
AIGAAPFK

SEQ ID NO: 35 - protein, 8 aa, Homo sapiens
EIYGEFKK

SEQ ID NO: 36 - protein, 8 aa, Artificial Sequence
  Description of Artificial Sequence Synthetic peptide
EAYGEAKK

SEQ ID NO: 37 - protein, 8 aa, Artificial Sequence
  Description of Artificial Sequence Synthetic peptide
EIAGEFKK

SEQ ID NO: 38 - protein, 6 aa, Artificial Sequence
  Description of Artificial Sequence Synthetic peptide
DRRASL

SEQ ID NO: 39 - protein, 6 aa, Artificial Sequence
  Description of Artificial Sequence Synthetic peptide
ERRASL

SEQ ID NO: 40 - protein, 6 aa, Artificial Sequence
  Description of Artificial Sequence Synthetic peptide
KRRASL

SEQ ID NO: 41 - protein, 6 aa, Artificial Sequence
  Description of Artificial Sequence Synthetic peptide
ARRASL

SEQ ID NO: 42 - protein, 6 aa, Artificial Sequence
  Description of Artificial Sequence Synthetic peptide
GRRASL

SEQ ID NO: 43 - protein, 6 aa, Artificial Sequence
  Description of Artificial Sequence Synthetic peptide
IRRASL

SEQ ID NO: 44 - protein, 6 aa, Artificial Sequence
  Description of Artificial Sequence Synthetic peptide
LRRASL

SEQ ID NO: 45 - protein, 6 aa, Artificial Sequence
  Description of Artificial Sequence Synthetic peptide
NRRASL

SEQ ID NO: 46 - protein, 6 aa, Artificial Sequence
  Description of Artificial Sequence Synthetic peptide
QRRASL

SEQ ID NO: 47 - protein, 6 aa, Artificial Sequence
  Description of Artificial Sequence Synthetic peptide
SRRASL

SEQ ID NO: 48 - protein, 6 aa, Artificial Sequence
  Description of Artificial Sequence Synthetic peptide
VRRASL

SEQ ID NO: 49 - protein, 6 aa, Artificial Sequence
  Description of Artificial Sequence Synthetic peptide
YRRASL

SEQ ID NO: 50 - protein, 6 aa, Artificial Sequence
  Description of Artificial Sequence Synthetic peptide
LRRDSL

SEQ ID NO: 51 - protein, 6 aa, Artificial Sequence
  Description of Artificial Sequence Synthetic peptide
LRRESL

SEQ ID NO: 52 - protein, 6 aa, Artificial Sequence
  Description of Artificial Sequence Synthetic peptide
LRRGSL

SEQ ID NO: 53 - protein, 6 aa, Artificial Sequence
  Description of Artificial Sequence Synthetic peptide
LRRISL

SEQ ID NO: 54 - protein, 6 aa, Artificial Sequence
  Description of Artificial Sequence Synthetic peptide
LRRLSL

SEQ ID NO: 55 - protein, 6 aa, Artificial Sequence
  Description of Artificial Sequence Synthetic peptide
LRRNSL

SEQ ID NO: 56 - protein, 6 aa, Artificial Sequence
  Description of Artificial Sequence Synthetic peptide
LRRQSL

SEQ ID NO: 57 - protein, 6 aa, Artificial Sequence
  Description of Artificial Sequence Synthetic peptide
LRRSSL

SEQ ID NO: 58 - protein, 6 aa, Artificial Sequence
  Description of Artificial Sequence Synthetic peptide
LRRVSL

SEQ ID NO: 59 - protein, 6 aa, Artificial Sequence
  Description of Artificial Sequence Synthetic peptide
LRRYSL

SEQ ID NO: 60 - protein, 6 aa, Artificial Sequence
  Description of Artificial Sequence Synthetic peptide
LRRASD

SEQ ID NO: 61 - protein, 6 aa, Artificial Sequence
  Description of Artificial Sequence Synthetic peptide
LRRASE

SEQ ID NO: 62 - protein, 6 aa, Artificial Sequence
  Description of Artificial Sequence Synthetic peptide
LRRASA

SEQ ID NO: 63 - protein, 6 aa, Artificial Sequence
  Description of Artificial Sequence Synthetic peptide
LRRASG

SEQ ID NO: 64 - protein, 6 aa, Artificial Sequence
  Description of Artificial Sequence Synthetic peptide
LRRASI

SEQ ID NO: 65 - protein, 6 aa, Artificial Sequence
  Description of Artificial Sequence Synthetic peptide
LRRASN

SEQ ID NO: 66 - protein, 6 aa, Artificial Sequence
  Description of Artificial Sequence Synthetic peptide
LRRASQ

SEQ ID NO: 67 - protein, 6 aa, Artificial Sequence
  Description of Artificial Sequence Synthetic peptide
LRRASS

SEQ ID NO: 68 - protein, 6 aa, Artificial Sequence
  Description of Artificial Sequence Synthetic peptide
LRRASV

SEQ ID NO: 69 - protein, 6 aa, Artificial Sequence
  Description of Artificial Sequence Synthetic peptide
LRRASY

SEQ ID NO: 70 - protein, 6 aa, Artificial Sequence
  Description of Artificial Sequence Synthetic peptide
WRRASL

SEQ ID NO: 71 - protein, 6 aa, Artificial Sequence
  Description of Artificial Sequence Synthetic peptide
LRRASK

SEQ ID NO: 72 - protein, 6 aa, Artificial Sequence
  Description of Artificial Sequence Synthetic peptide
GVPRGV

SEQ ID NO: 73 - protein, 4 aa, Artificial Sequence
  Description of Artificial Sequence Synthetic peptide
SQNY

(19) United States
(12) Patent Application Publication
(10) Pub. No.: US 2010/0093554 A1
(43) Pub. Date: Apr. 15, 2010

(54) Methods for identifying biomarkers, autoantibody signatures, and stratifying subject groups using peptide arrays

(76) Inventor: Keting Chu, Hillsborough, CA (US)

Correspondence Address: WILSON, SONSINI, GOODRICH & ROSATI, 650 PAGE MILL ROAD, PALO ALTO, CA, 94304-1050, US

(21) Appl. No.: 12/156,657

(22) Filed: Jun. 2, 2008

Related U.S. Application Data
(60) Provisional application No. 60/941,413, filed on Jun. 1, 2007.
(60) Provisional application No. 61/035,727, filed on Mar. 11, 2008.

(51) Int. Cl. C40B 30/04; C40B 40/10

(52) U.S. Cl. 506/9; 506/18

(57) ABSTRACT

Peptide arrays and uses thereof for diagnostics, therapeutics and research. Ultra high density peptide arrays are generated using photolithography, such as using photoresist techniques.

### CROSS-REFERENCE

This application claims the benefit of U.S. Provisional Application No. 60/941,413 filed on Jun. 1, 2007 and U.S. Provisional Application No. 61/035,727 filed on Mar. 11, 2008, all of which are incorporated herein by reference in their entirety. Cross reference is made to co-pending U.S. patent application Ser. Nos. ______, entitled: “Proteome Peptide Arrays”; ______, entitled: “Disease Related Peptide Arrays And Methods Of Use”; ______, entitled: “Methods For Diagnosing Or Prognosing A Condition Using Peptide Arrays”; ______, entitled: “Methods For Identifying Antibody Epitopes Using Peptide Arrays”; ______, entitled: “Methods For Monitoring Drug Treatment Using Peptide Arrays”; ______207______, entitled: “High Density Peptide Arrays Containing Kinase Or Phosphatase Substrates”; ______, entitled: “Methods Of Using High Density Peptide Arrays Containing Kinase Or Phosphatase Substrates”; ______, entitled: “High Density Peptide Arrays Containing Protease Substrates”; ______, entitled: “High Density Peptide Arrays”; ______, entitled: “Methods Of Manufacturing High Density Peptide Arrays” and PCT Patent Application Number ______ entitled; “Peptide Arrays And Methods Of Use”, which are filed on Jun. 2, 2008, which are hereby incorporated by reference in their entirety.

### BACKGROUND

Screening mechanisms to identify peptides binding domains (e.g., enzyme substrates, therapeutic peptides, etc.) are extremely valuable. While there are some peptide arrays available commercially, such spotted arrays have low density and relatively low fidelity. Thus, there is a need for a better high density, high fidelity, robust system for analyzing peptides and the proteome.

### SUMMARY OF THE INVENTION

The present invention relates to compositions and methods for creating peptide arrays using photolithography and methods of using the peptide arrays produced by photolithography. The peptide arrays of the present invention can be produced by photoresist technology. In general, the invention features methods for identifying biomarkers, autoantibody signatures, and stratifying subject groups using peptide arrays.

The inventions described herein include those disclosed in U.S. Provisional Application Ser. Nos. 60/941,413 filed on Jun. 1, 2007 and 61/035,727 filed on Mar. 11, 2008, both of which hereby are incorporated in their entirety by reference.

Implementation of the invention can include one or more of the following features.

In general, in one aspect, a method for identifying a biomarker for a condition is provided, including applying a sample from a subject with said condition to a first peptide array, applying a sample from a subject without said condition to a second peptide array having the same configuration as said first peptide array, comparing a binding property of the sample from the subject with the condition with a binding property of the sample from the subject without the condition to identify the biomarker for the condition.

The array can contain a set of peptides whose sequence is derived from proteins expressed from oncogenes. The oncogenes can include v-myc, N-MYC, L-MYC, v-myb, v-fos, v-jun, v-ski, v-rel, v-ets-1, v-ets-2, v-erbA1, v-erbA2, BCL2, MDM2, ALL1(MLL), v-sis, int2, KS3, HST, EGFR, v-fms, v-KIT, v-ros, MET, TRK, NEU, RET, mas, SRC, v-yes, v-fgr, fes, ABL, H-RAS, K-RAS, N-RAS, BRAF, gsp, gip, Dbl, Vav, v-mos, v-raf, pim-1, v-crk.

The set of peptides can be from antigens that elicit antibodies in subjects with an autoimmune disorder. The peptides can include at least 50%, 90%, or all of the entire sequence of all known antigens that elicit antibodies in a subject having an autoimmune disease. The set of peptides can be from viral proteins. The set of peptides can be derived from a single viral family. The set of peptides can be derived from multiple viral families. The set of peptides can be derived from all viruses. The set of proteins can be viral envelope proteins. The set of peptides can include at least 50%, 90%, or all of the sequences of all viral envelope proteins of a viral family or all viruses. The set of peptides can include at least 50%, 90%, or all of the sequences of all proteins from all viruses.

The set of peptides can include at least 10%, 50%, 90%, or all of the proteome of an organ or organism. The peptides can be at least 10%, 50%, 90%, or all of the predicted MHC class II binding peptides of an organ or organism. The organism can be a human. The organism can be infectious. The organism can be a microorganism. The organ can be liver, kidney, or heart.

The set of peptides can be from an infectious agent.

The condition can be cancer, an autoimmune disorder, an infectious disease, an epidemic, transplant rejection, a metabolic disease, cardiovascular disease, a dermatological disease, a hematological disease, or a neurodegenerative disease. The neurodegenerative disease can be Parkinson's disease or Alzheimers.

The condition can be caused by bio-terrorist activity.

The peptides can include at least 9 monomers or 6-150 monomers. Each of the at least subset of peptides can have an amino acid sequence shift of one amino acid position with respect to at least one other peptide. The sequences of a set of peptides on the array can overlap. The peptides can be antigenic.

The sample can be a serum sample.

The array can include at least 10,000, 50,000, 500,000, 1,000,000, 2,000,000, 3,000,000, 10,000,000, 20,000,000 or 100,000,000 features. The feature area can be less than 1 um2. Up to 70% of the peptides can be full-length when compared to the predetermined peptide sequences. Up to 80% of said peptides can be identical to predetermined sequences used to synthesize the peptides.

Photolithography and photoresist can be used to create the array of peptides. Photo acid generation can be used to generate peptides. Acids can be generated electronically to generate peptides. Masks can be used to generate peptides. Micromirrors can be used to generate peptides.

In general, in one aspect, a method for stratifying subject groups, comprising applying serum samples from multiple subjects to multiple peptide arrays, wherein each array has the same configuration; analyzing binding of molecules to said peptide arrays; and placing patients into treatment groups based on said binding analysis.

The array can contain a set of peptides whose sequence are derived from proteins expressed from oncogenes. The oncogenes can be selected from the list including v-myc, N-MYC, L-MYC, v-myb, v-fos, v-jun, v-ski, v-rel, v-ets-1, v-ets-2, v-erbA1, v-erbA2, BCL2, MDM2, ALL1(MLL), v-sis, int2, KS3, HST, EGFR, v-fms, v-KIT, v-ros, MET, TRK, NEU, RET, mas, SRC, v-yes, v-fgr, v-fes, ABL, H-RAS, K-RAS, N-RAS, BRAF, gsp, gip, Dbl, Vav, v-mos, v-raf, pim-1, v-crk.

The set of peptides can be from antigens that elicit antibodies in subjects with an autoimmune disorder. The peptides can include at least 50%, 90%, or all of the entire sequence of all known antigens that elicit antibodies in a subject having an autoimmune disease.

The set of peptides can be from viral proteins. The set of peptides can be derived from a single viral family. The set of peptides can be derived from multiple viral families. The set of peptides can be derived from all viruses. The set of proteins can be viral envelope proteins. The set of peptides can include at least 50%, 90%, or all of the sequences of all viral envelope proteins of a viral family or all viruses. The set of peptides can include at least 50%, 90%, or all of the sequences of all proteins from all viruses.

The set of peptides can include at least 10%, 50%, 90%, or all of the proteome of an organ or organism.

The peptides can be 10%, 50%, 90%, or all of the predicted MHC class II binding peptides of an organ or organism. The organism can be a human. The organism can be infectious. The organism can be a microorganism. The organ can be liver, kidney, or heart.

The set of peptides can be from an infectious agent.

A subset of subjects can have cancer, an autoimmune disorder, an infectious disease, a condition caused by an epidemic, transplant rejection, or a condition caused by bio-terrorist activity.

The peptides can include at least 6 monomers or 6-150 monomers. Each of the plurality of peptides can have an amino acid sequence shift of one amino acid position with respect to at least one other peptide. The sequences of a set of peptides on the array can overlap. The peptides can be antigenic.

The sample can be a serum sample.

The array can include at least 10,000, 50,000, 500,000, 1,000,000, 2,000,000, 3,000,000, 10,000,000, 20,000,000 or 100,000,000 features.

The feature area can be less than 1 um2. Up to 70% of the peptides can be full-length when compared to the predetermined peptide sequences. Up to 80% of the peptides can be identical to predetermined sequences used to synthesize the peptides.

Photolithography and photoresist can be used to create the array. Photo acid generation can be used to create the array. Acids can be generated electronically to create the array. Masks can be used to create the array. Micromirrors can be used to create the array.

In general, in yet another aspect, a method for identifying autoantibody signatures for a condition is provided, including applying a serum sample from a subject with said condition to a first peptide array, applying a serum sample from a subject without said condition to a second peptide array having the same configuration as said first peptide array, evaluating binding of one or more molecules of said serum sample from said subject with said condition to said first peptide array, evaluating binding of one or more molecules of said serum sample from said subject without said condition to said second peptide array; and comparing c) with d) to identify an antibody signature.

The set of peptides can have sequence derived from proteins expressed from oncogenes. The oncogenes can be selected from the list including v-myc, N-MYC, L-MYC, v-myb, v-fos, v-jun, v-ski, v-rel, v-ets-1, v-ets-2, v-erbA1, v-erbA2, BCL2, MDM2, ALL1(MLL), v-sis, int2, KS3, HST, EGFR, v-fms, v-KIT, v-ros, MET, TRK, NEU, RET, mas, SRC, v-yes, v-fgr, v-fes, ABL, H-RAS, K-RAS, N-RAS, BRAF, gsp, gip, Dbl, Vav, v-mos, v-raf, pim-1, v-crk.

The set of peptides can be from antigens that elicit antibodies in subjects with an autoimmune disorder. The peptides can include 50%, 90%, or all of the entire sequence of all known antigens that elicit antibodies in a subject having an autoimmune disease.

The set of peptides can be derived from all viruses. The set of peptides can include at least 10%, 50%, 90%, or all of the proteome of an organ or organism. The peptides can be 10%, 50%, 90%, or all of the predicted MHC class II binding peptides of an organ or organism. The organism can be a human. The organ can be liver, kidney, or heart.

The condition can be cancer, an autoimmune disorder, an infectious disease, an epidemic, transplant rejection, a metabolic disease, cardiovascular disease, a dermatological disease, a hematological disease, or a neurodegenerative disease. The neurodegenerative disease can be Parkinson's disease or Alzheimers.

The condition can be caused by bio-terrorist activity.

The peptides can include at least 6 monomers or 6-150 monomers. Each of the plurality of peptides can have an amino acid sequence shift of one amino acid position with respect to at least one other peptide. The sequences of a set of peptides on the array can overlap.

The peptides can be antigenic.

The sample can be a serum sample.

The array can include at least 10,000, 50,000, 500,000, 1,000,000, 2,000,000, 3,000,000, 10,000,000, 20,000,000 or 100,000,000 features.

The feature area can be less than 1 um2. Up to 70% of the peptides can be full-length when compared to the predetermined peptide sequences. Up to 80% of the peptides can be identical to predetermined sequences used to synthesize the peptides.

Photolithography and photoresist can be used to create the array. Photo acid generation can be used to create the array. Acids can be generated electronically to create the array. Masks can be used to create the array. Micromirrors can be used to create the array.

### INCORPORATION BY REFERENCE

All publications and patent applications mentioned in this specification are herein incorporated by reference to the same extent as if each individual publication or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 illustrates steps for in situ synthesis of peptides on a support using photolithography and photoresist.

FIG. 2 depicts chemical reactions for photo acid generation for deprotection of monomers.

FIG. 3 illustrates photo acid generation and sensitizers suspended in the polymeric medium.

FIGS. 4 A and B illustrates the stepwise synthesis efficiency for the synthesis of a penta glycine peptide.

FIGS. 5 A, B, and C depict exemplary G protein-coupled receptor signaling pathways.

FIG. 6 illustrates a DNA damage pathway.

FIG. 7 illustrates two examples of apoptosis pathways.

FIG. 8 is an exemplary signaling pathway associated with neurodegenerative diseases.

FIG. 9 illustrates pathways involved in Alzheimer's disease.

FIG. 10 illustrates peptides that form a substrate peptide cluster. Each peptide represents the sequence of a peptide in a feature that forms the peptide cluster. Each sequence has a single Ser, Thr, or Tyr, as represented by the dark circles. The Ser, Thr, or Tyr is in a different monomer position for each peptide in the cluster. The other surrounding amino acids remain the same between all peptides within the cluster.

FIG. 11 illustrates one peptide sequence that is part of a substrate peptide cluster. Each peptide sequence has a single Ser, Thr, or Try in position 5.

FIG. 12 illustrates peptides that form a substrate peptide cluster, wherein each peptide represents the monomer sequence of a feature that forms the peptide cluster. The peptide sequences are derived from a known sequence and overlap with other peptide sequences in the peptide cluster that also represent a portion of the known, or common sequence.

FIG. 13 A) is a schematic of a sample with a mixture of kinases used in a kinase assay with the peptide array; B) is a graph showing that Src kinase and Abl kinase in the same sample do not interfere with each other and can be used in the same kinase assay.

FIG. 14 illustrates a peptide sequence consisting of 9 monomers for a kinase peptide array and a signal for detection of phosphorylation.

FIG. 15 illustrates an EC50 study for Src kinase sensitivity in a kinase assay.

FIG. 16 depicts the sequences of peptides on an array. Abl kinase phosphorylates the wild-type (WT) Abl substrate peptide and Src phosphorylates the WT Src substrate peptide.

FIG. 17 A) shows the peptide arrays that detect Abl, Src, or both; and a chart showing the signal to noise ratio (SNR). B) is a graph depicting detection of WT kinase activity compared to and mutant kinase and background using peptide arrays.

FIG. 18 depicts graphs along with the peptide arrays from which the data was obtained. PKA and PKB, kinases of the same family, have different activity against specific peptide substrates. The kinases show a difference in preferred specificity in position −4 (4 amino acids shifted from the phosphorylation site, Serine “S”), −1 (one position from phosphorylation site), and +1 (one position from the serine).

FIG. 19: depicts graphs along with the peptide arrays from which the data was obtained. PKC has a different sequence preference in comparison to PKA and PKB. PKC shows a different preference in position −4 (4 amino acids shifted from the phosphorylation site, Serine “S”) and +1 (one position from the serine).

FIG. 20 depicts the positional preference of the AGC family kinases PKA, PKB, and PKC. The preference was based on relative signal intensity over kemptide. The bolded residues are from previously published work whereas the other residues were not published.

FIG. 21 is a graph showing a peptide array kinase inhibition assay. The ATP competitive inhibitor, staurosporin (“Stau.”) inhibited Src kinase activity by up to 80%. The IC50 was estimated to be approximately 450 nM.

FIG. 22 depicts Gleevac inhibition on different forms of Abl kinase. Gleevac inhibition of phosphorylated Abl kinase, non phosphorylated Abl kinase, and Src kinase, or both, was tested using peptide arrays with Abl and Src substrates. A) Gleevac does not have an effect on phosphorylated Abl kinase nor Src kinase activity. B) Gleevac inhibits the activity of non phosphorylated Abl kinase. C) The peptide arrays used for testing kinase activity of phosphorylated Abl and Src, with or without Gleevac. D) The peptide arrays used for testing kinase activity of non phosphorylated Abl and Src, with or without Gleevac. E) A chart showing the percent inhibition of Gleevac.

FIG. 23 shows the specificity of different kinase inhibitors on Abl and Src. Activity is measured using peptide arrays with Abl and Src peptide substrates.

FIG. 24 depicts a schematic of a peptide on an array with a cleavage site and fluorophore for use in cleavage assays.

FIG. 25 shows a graph of the cleavage assay for trypsin. The sequence of the substrate is depicted below the graph.

FIG. 26 shows the fluorescence intensity of the peptide array before and after assay with HIV-1 protease. The peptide substrate is shown above the graphs, the cleavage site is in bold.

FIG. 27 illustrates an antibody binding experiment comparing binding of peptides synthesized using photo acid generation or TFA to a p53 primary antibody and fluorescein conjugated secondary antibody.

### DETAILED DESCRIPTION OF THE INVENTION

The present invention relates to peptide arrays, methods of manufacturing peptides arrays, and various applications of such peptide arrays. Peptide arrays are preferably generated using one or more of the methods described below.

### Methods of Manufacturing Peptide Arrays

### Overview of Photolithography and In Situ Peptide Synthesis on a Support

The peptides of the arrays of the present invention are synthesized in situ on a support. In some instances, the peptide arrays are made using photolithography. Photolithography involves the use of microfabrication to selectively remove parts of a thin film (or the bulk of a support). Light can be used to transfer a geometric pattern from a photomask (or mask) to a light-sensitive chemical (e.g., photoresist) on the support. A series of chemical treatments then engraves the exposure pattern into the material underneath the photoresist, examples of which are described herein.

To achieve spatially defined combinatorial polymer synthesis on a support surface, masks can be used to control radiation or light exposure to specific locations on a surface provided with linker molecules containing radiation (or photo)-labile protecting groups. In the exposed locations, the radiation-labile protecting groups are removed. The surface is then contacted with a solution containing a monomer. The monomer can have at least one site that is reactive with the newly exposed reactive moiety on the linker and at least a second reactive site protected by one or more radiation-labile protecting groups. The desired monomer is then coupled to the unprotected linker molecules. The process can be repeated to synthesize a large number of polymers in specific locations on a support (See, for example, U.S. Pat. No. 5,143,854 to Pirrung et al., U.S. Patent Application Publication Nos. 2007/0154946 (filed on Dec. 29, 2005), 2007/0122841 (filed on Nov. 30, 2005), 2007/0122842 (filed on Mar. 30, 2006), and 2008/0108149 (filed on Oct. 23, 2006).

### Maskless Photolithography Using Micromirrors

An alternative to photolithographic masks is the use of micromirrors, which comprises an array of switchable optical elements such as a two-dimensional array of electronically addressable. Projection optics focuses an image of the micromirrors on the support where the reactions for polymers are conducted. Under the control of a computer, each of the micromirrors is selectively switched between a first position at which it projects light on the substrate through the optical system and a second position at which it deflects light away from the substrate. The plurality of small and individually controllable rocking-mirrors can steer light beams to produce images or light patterns. Reactions at different regions on the solid support can be modulated by providing irradiation of different strengths using such micromirror device, or digital micromirror device (DMD), which is a programmable photoreaction optical device.

Micromirror devices are available commercially, such as Texas Instruments' digital light projector (DLP). The controlled light irradiation allows control of the reactions to proceed at a desirable rate. Such devices are discussed for example, in Hornbeck, L. J., “Digital light processing and MEMS, reflecting the digital display needs of the networked society,” SPIE Europe Proceedings, 2783, 135-145 (1996), U.S. Pat. Nos. 5,096,279, 5,535,047, 5,583,688 and 5,600,383. Other types of electronically controlled display devices may be used for generating light patterns. For example, a reflective liquid crystal array display (LCD) device, commercially available from a number of companies, such Displaytech, Inc. Longmont, Colo. USA, can contain a plurality of small reflectors with a liquid crystal shutter placed in front of each reflector to produce images or light patterns. A transmissive LCD display can also be used to generate light patterns. A transmissive LCD display containing a plurality of liquid crystal light valves have valves that are on, so light passes; and when a liquid crystal light valve is off, light is blocked. Therefore, a transmissive LCD display can be used in the same way as an ordinary photomask is used in a standard photolithography process (L. F. Thompson et al., “Introduction to Microlithography”, American Chemical Society, Washington, D.C. (1994)). See also Gao et al. “Light directed massively parallel on-chip synthesis of peptide arrays with t-Boc chemistry” Proteomics 2003, 3, 2135-2141 and Ishikawa (WO/2000/003307) “MASKLESS PHOTOLITHOGRAPHY SYSTEM”.

### In Situ Peptide Synthesis on a Solid Support

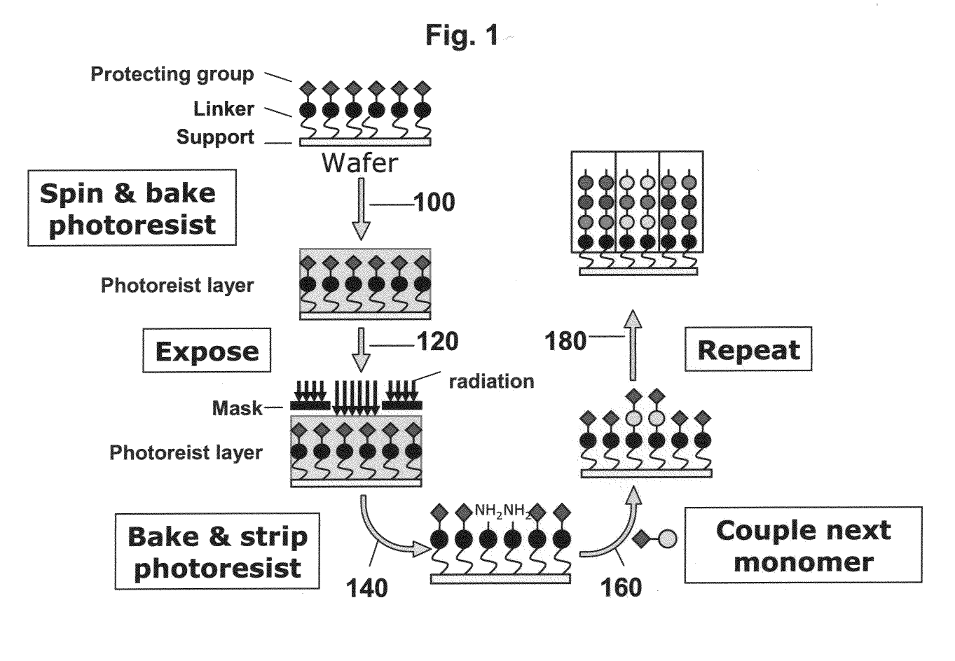

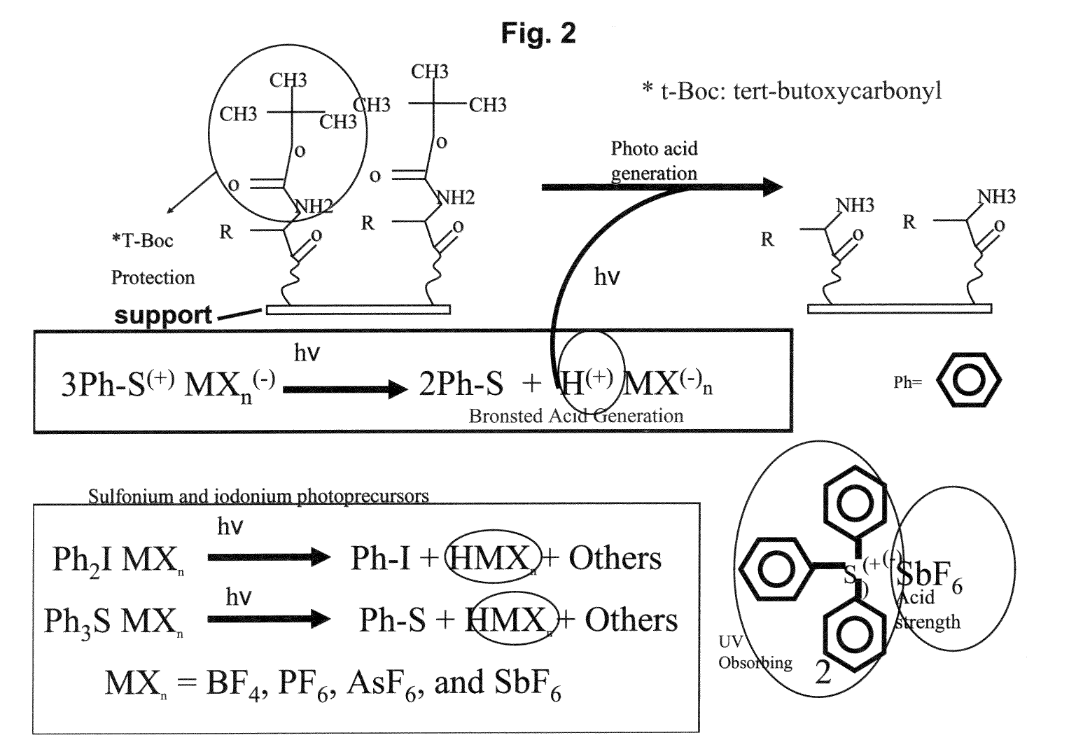

In some instances, photoresist and photolithography are used for the in situ synthesis of peptides on a support, as illustrated in FIG. 1. First, linker molecules with protecting groups are attached to a solid support. Next, photoresist is applied to the surface of the support (100). The photoresist layer can include a polymer, a photosensitizer, and a photo-active agent. Photoresist can be applied by a spin-coating method, and the photoresist-coated support can then be baked. Baking promotes removal of excess solvent from the photoresist and provides for a uniform film. Next, a photomask is placed over the photoresist layer to restrict regions that will be exposed to radiation (120). Radiation is then transmitted through the photomask onto the photoresist layer (120). Radiation exposure of the photoresist results in reagents that can cleave the protecting groups from molecules. The cleaving reagent may be generated owing to absorption of light by a photosensitizer followed by reaction of the photosensitizer with the cleavage reagent precursor, energy transfer from the photosensitizer to the cleavage reagent precursor, or a combination of two or more different mechanisms.

Protecting groups are cleaved from the molecules in areas that were exposed, to radiation, whereas the protecting groups will not be cleaved from molecules that were not exposed. Removal of protecting groups can be accelerated by heating (baking) the support after the radiation exposure.

After radiation exposure, the photoresist is removed (140). Deprotected molecules are available for further reaction whereas molecules that retain their protective groups are not available for further reaction (160). The processes may be repeated to form polymers on the support surface (180) (see also, e.g., U.S. Pat. No. 5,677,195 to Winkler et al.).

### Supports

The solid support, or support, refers to a material or group of materials having a rigid or semi-rigid surface or surfaces. In some aspects, at least one surface of the solid support will be substantially flat, although in some aspects it may be desirable to physically separate synthesis regions for different molecules with, for example, wells, raised regions, pins, etched trenches, or the like. In certain embodiments, the solid support may be porous.

Support materials useful in embodiments of the present invention include, for example, silicon, bio-compatible polymers such as, for example poly(methyl methacrylate) (PMMA) and polydimethylsiloxane (PDMS), glass, SiO2 (such as, for example, a thermal oxide silicon wafer such as that used by the semiconductor industry), quartz, silicon nitride, functionalized glass, gold, platinum, and aluminum. Functionalized surfaces include for example, amino-functionalized glass, carboxy functionalized glass, and hydroxy functionalized glass. Additionally, a support may optionally be coated with one or more layers to provide a surface for molecular attachment or functionalization, increased or decreased reactivity, binding detection, or other specialized application. Support materials and or layer(s) may be porous or non-porous. For example, a support may be comprised of porous silicon. Additionally, the support may be a silicon wafer or chip such as those used in the semiconductor device fabrication industry. In the case of a wafer or chip, a plurality of arrays may be synthesized on the wafer. A person skilled in the art would know how to select an appropriate support material.

### Linker Molecules

The peptides present on the array may be linked covalently or non-covalently to the array, and can be attached to the array support (e.g., silicon or other relatively flat material) by cleavable linkers. A linker molecule can be a molecule inserted between the support and peptide that is being synthesized, and a linker molecule may not necessarily convey functionality to the resulting peptide, such as molecular recognition functionality, but instead elongates the distance between the support surface and the peptide functionality to enhance the exposure of the peptide functionality on the surface of the support. Preferably a linker should be about 4 to about 40 atoms long to provide exposure. The linker molecules may be, for example, aryl acetylene, ethylene glycol oligomers containing 2-10 monomer units (PEGs), diamines, diacids, amino acids, among others, and combinations thereof. Examples of diamines include ethylene diamine and diamino propane. Alternatively, the linkers may be the same molecule type as that being synthesized (i.e., nascent polymers), such as polypeptides and polymers of amino acid derivatives such as for example, amino hexanoic acids. A person skilled in the art would know how to design appropriate linkers.

### Monomers

The monomers used for peptide synthesis can include amino acids. In some instances all peptides on an array are composed of naturally occurring amino acids. In others, peptides on an array can be composed of a combination of naturally occurring amino acids and non-naturally occurring amino acids. In other cases, peptides on an array can be composed solely from non-naturally occurring amino acids. Non-naturally occurring amino acids include peptidomimetics as well as D-amino acids. The R group can be found on a natural amino acid or a group that is similar in size to a natural amino acid R group. Additionally, unnatural amino acids, such as β-alanine, phenylglycine, homoarginine, aminobutyric acid, aminohexanoic acid, aminoisobutyric acid, butylglycine, citrulline, cyclohexylalanine, diaminopropionic acid, hydroxyproline, norleucine, norvaline, ornithine, penicillamine, pyroglutamic acid, sarcosine, and thienylalanine can also be incorporated by the embodiments of the invention. These and other natural and unnatural amino acids are available from, for example, EMD Biosciences, Inc., San Diego, Calif.

### Protecting Groups

The unbound portion of the linker molecule, or free end of the linker molecule, can have a reactive functional group which is blocked, protected or otherwise made unavailable for reaction by a removable protective group. The protecting group can be bound to a monomer, a polymer, a linker molecule or a monomer, or polymer, or a linker molecule attached to a solid support to protect a reactive functionality on the monomer, polymer, or linker molecule. Protective groups that may be used in accordance with an embodiment of the invention include all acid and base labile protecting groups. For example, peptide amine groups can be protected by t-butoxycarbonyl (t-BOC or BOC) or benzyloxycarbonyl (CBZ), both of which are acid labile, or by 9-fluorenylmethoxycarbonyl (FMOC), which is base labile.

Additional protecting groups that may be used in accordance with embodiments of the invention include acid labile groups for protecting amino moieties: tert-amyloxycarbonyl, adamantyloxycarbonyl, 1-methylcyclobutyloxycarbonyl, 2-(p-biphenyl)propyl(2)oxycarbonyl, 2-(p-phenylazophenylyl)propyl(2)oxycarbonyl, α,α-dimethyl-3,5-dimethyloxybenzyloxy-carbonyl, 2-phenylpropyl(2)oxycarbonyl, 4-methyloxybenzyloxycarbonyl, furfuryloxycarbonyl, triphenylmethyl (trityl), p-toluenesulfenylaminocarbonyl, dimethylphosphinothioyl, diphenylphosphinothioyl, 2-benzoyl-1-methylvinyl, o-nitrophenylsulfenyl, and 1-naphthylidene; as base labile groups for protecting amino moieties: 9 fluorenylmethyloxycarbonyl, methylsulfonylethyloxycarbonyl, and 5-benzisoazolylmethyleneoxycarbonyl; as groups for protecting amino moieties that are labile when reduced: dithiasuccinoyl, p-toluene sulfonyl, and piperidino-oxycarbonyl; as groups for protecting amino moieties that are labile when oxidized: (ethylthio)carbonyl; as groups for protecting amino moieties that are labile to miscellaneous reagents, the appropriate agent is listed in parenthesis after the group: phthaloyl (hydrazine), trifluoroacetyl (piperidine), and chloroacetyl (2-aminothiophenol); acid labile groups for protecting carboxylic acids: tert-butyl ester; acid labile groups for protecting hydroxyl groups: dimethyltrityl. (See also, Greene, T. W., Protective Groups in Organic Synthesis, Wiley-Interscience, NY, (1981)). A person skilled in the art would know how to select an appropriate protecting group.

### Photoresist Formulations

Photoresist formulations useful in the present invention can include a polymer, a solvent, and a radiation-activated cleaving reagent. Useful polymers include, for example, poly(methyl methacrylate) (PMMA), poly-(methyl isopropenyl ketone) (PMPIK), poly-(butene-1-sulfone) (PBS), poly-(trifluoroethyl chloroacrylate) (TFECA), copolymer-(.alpha.-cyano ethyl acrylate-.alpha.-amido ethyl acrylate (COP), and poly-(2-methyl pentene-1-sulfone). Useful solvents include, for example, propylene glycol methyl ether acetate (PGMEA), ethyl lactate, and ethoxyethyl acetate. The solvent used in fabricating the photoresist may be selected depending on the particular polymer, photosensitizer, and photo-active compound that are selected. For example, when the polymer used in the photoresist is PMMA, the photosensitizer is isopropyl-thioxanthenone, and the photoactive compound is diphenyliodonium chloride, PGMEA or ethyl lactate may be used as the solvent.

In exemplary photoresist formulations, the mass concentration of the polymer may between about 5% and about 50%, the mass concentration of a photosensitizer may be up to about 20%, the mass concentration of the photo-active compound may be between about 1% and 10%, the balance comprising a suitable solvent. After the photoresist is deposited on the support, the support typically is heated to form the photoresist layer. Any method known in the art of semiconductor fabrication may be used to for depositing the photoresist solution. For example, the spin coating method may be used in which the support is spun typically at speeds between about 1,000 and about 5,000 revolutions per minute for about 30 to about 60 seconds. The resulting wet photoresist layer has a thickness ranging between about 0.1 μm to about 2.5 μm.

In some instances the photoresist can include radiation-activated catalysts (RAC), or more specifically photo activated catalysts (PACs). Photosensitive compounds act as catalysts to chemically alter synthesis intermediates linked to a support to promote formation of polymer sequences. Alternatively, RACs can activate an autocatalytic compound which chemically alters the synthesis intermediate in a manner to allow the synthesis intermediate to chemically combine with a later added synthesis intermediate or other compound. For example, one or more linker molecules are bound to or otherwise provided on the surface of a support.

Catalysts for protective group removal (also referred to as cleaving reagents) useful in the present invention include acids and bases. For example, acids can be generated photochemically from sulfonium salts, halonium salts, and polonium salts. Sulfonium ions are positive ions, R₃S⁺, where R is, for example, a hydrogen or alkyl group, such as methyl, phenyl, or other aryl group. In general, halonium ions are bivalent halogens, R₂X⁺, where R is a hydrogen or an alkyl group, such as methyl, phenyl, or other aryl group, and X is a halogen atom. The halonium ion may be linear or cyclic. Polonium salt refers to a halonium salt where the halogen is iodine, the compound R₂I⁺Y⁻, where Y is an anion, for example, a nitrate, chloride, or bromide. See also, Frechet, J. M. J., Ito, H., Willson, C. G., Proc. Microcircuit Eng., 260, (1982); Shirai, M., Tsunooka, M., Prog. Polym. Sci., 21:1, (1996); Frechet, J. M. J., Eichler, E, Ito, H., Willson, C. G., Polymer, 24:995, (1983); and Frechet, J. M. J., Ito, H., Willson, C. G., Tessier, T. G., Houlihan, F. M. J., J. of Electrochem. Soc., 133:181 (1986).

Photogenerated bases include amines and diamines having photolabile protecting groups. See for example, Shirai, M., Tsunooka, M., Prog. Polym. Sci., 21:1, (1996); Comeron, J. F., Frechet, J. M. J., J. Org. Chem., 55:5919, (1990); Comeron, J. F., Frechet, J. M. J., J. Am. Chem. Soc., 113:4303, (1991); and Arimitsu, K. and Ichimura, K., J. Mat. Chem., 14:336, (2004).

Optionally, the photoresists useful in the present invention may also include a photosensistizer. In general, a photosensitizer absorbs radiation and interacts with the RAC, such as PAG, through one or more mechanisms, including, energy transfer from the photosensitizer to the cleavage reagent precursor, thereby expanding the range of wavelengths of radiation that can be used to initiate the desired catalyst-generating reaction. As such, the photosensitizer can be a radiation sensitizer, which is any material that shifts the wavelengths of radiation required to initiate a desired reaction. Useful photosensitizers include, for example, benzophenone and other similar diphenyl ketones, thioxanthenone, isopropylthioxanthenone, anthraquinone, fluorenone, acetophenone, and perylene. Thus, the photosensitizer allows the use of radiation energies other than those at which the absorbance of the radiation-activated catalyst is non-negligible.

The present invention may also further include the presence of an enhancer that is ester labile to acid catalyzed thermolytic cleavage, itself produces an acid, enhancing the removal of protective groups. The enhancer can be any material that amplifies a radiation-initiated chemical signal so as to increase the effective quantum yield of the radiation. Enhancers include, but are not limited to, catalytic materials. The use of an enhancer in radiation-assisted chemical processes is termed chemical amplification. Chemical amplification has many benefits. Non limiting examples of the benefit of chemical amplification include the ability to decrease the time and intensity of irradiation required to cause a desired chemical reaction. Chemical amplification also improves the spatial resolution and contrast in patterned arrays formed using this technique.

The enhancer is a compound or molecule that can be added to a photoresist in addition to a radiation-activated catalyst. An enhancer can by activated by the catalyst produced by the radiation-induced decomposition of the RAC and autocatalyticly reacts to further (above that generated from the radiation-activated catalyst) generate catalyst concentration capable of removing protecting groups. For example, in the case of an acid-generating RAC, the catalytic enhancer can be activated by acid and or acid and heat and autocatalyticly reacts to form further catalytic acid, that is, its decomposition increases the catalytic acid concentration. The acid produced by the catalytic enhancer removes protecting groups from the growing polymer chain.

FIG. 2 shows the photogeneration of an acid and the deprotection of an amine group of a surface-attached amino acid. A support surface is provided having a first amino acid attached to the surface. In this example, the first amino acid is N-protected with a t-BOC (tert-butoxycarbonyl) protecting group. The support surface is coated with a photoresist, and in this example the photoresist contains the phoactivated acid generator triaryl sulfonium hexafluoroantimonatate (TASSbF₆). Upon exposure to radiation, an acid is produced in the photoresist and the N-protecting group is removed from the attached peptide in the region of UV exposure.

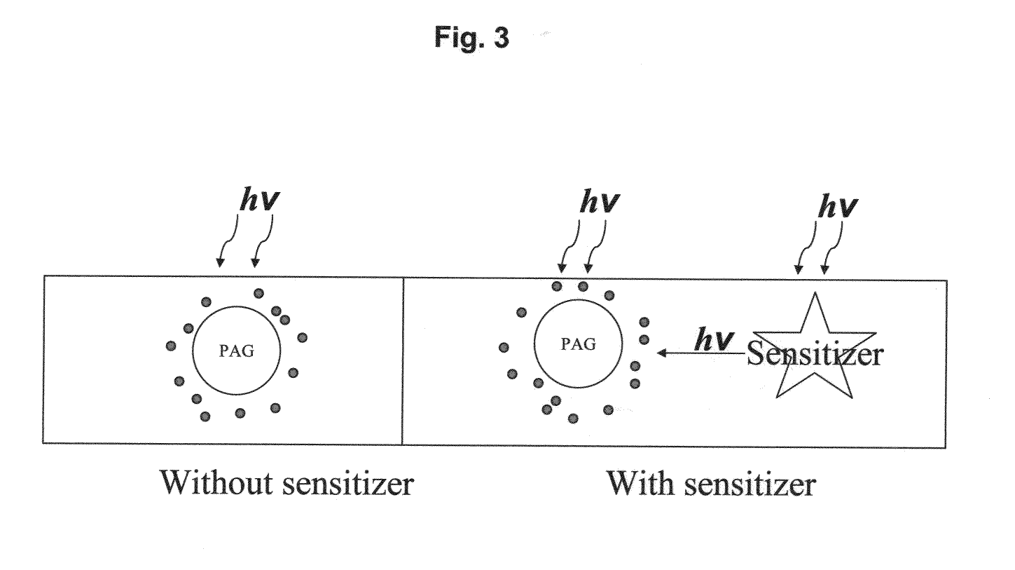

FIG. 3 illustrates means of photo-acid generation (PAG). Acids can be generated photochemically. Alternatively, the cleaving reagent may be generated owing to absorption of light by a photosensitizer followed by reaction of the photosensitizer with the cleavage reagent precursor, energy transfer from the photosensitizer to the cleavage reagent precursor, or a combination of two or more different mechanisms.

### Deprotection and Coupling

Using the techniques disclosed herein, it is possible to advantageously irradiate relatively small and precisely known locations on the surface of the support (e.g., within 1 μm² or 0.5 μm²). The radiation does not directly cause the removal of the protective groups, such as through a photochemical reaction upon absorption of the radiation by the synthesis intermediate or linker molecule itself, but rather the radiation acts as a signal to initiate a chemical catalytic reaction which removes the protective group in an amplified manner. Therefore, the radiation intensity as used in the practice of the present invention to initiate the catalytic removal by a catalyst system of protecting groups can be much lower than, for example, direct photo removal, which can result in better resolution when compared to many non-amplified techniques.

Acids or bases can be used to remove the protective group, and the functional group is made available for reaction, i.e. the reactive functional group is unblocked. A PAC is located or otherwise provided on the surface of the support in the vicinity of the linker molecules, for example in a photoresist layer coating the support. The PAC by itself or in combination with additional catalytic components is referred to herein as a catalyst system. Using lithographic methods and techniques well known to those of skill in the art, a set of first selected regions on the surface of the support can be exposed to radiation of certain wavelengths. The radiation activates the PAC which then either directly or through an autocatalytic compound catalytically removes the protecting group from the linker molecule making it available for reaction with a subsequently added synthesis intermediate. The autocatalytic compound can then undergo a reaction producing at least one product that removes the protective groups from the linker molecules in the first selected regions.

In one embodiment, the RAC produces an acid when exposed to radiation, the monomer can be an amino acid containing an acid removable protecting group at its amino or carboxy terminus, and the linker molecule terminates in an amino or carboxy acid group bearing an acid removable protective group. The embodiment may further include the presence of an enhancer that is ester labile to acid catalyzed thermolytic cleavage, itself produces an acid, enhancing the removal of protective groups.

The use of PACs and autocatalytic compounds initiates a chemical reaction which catalyzes the removal of a large number of protective groups. With the protective groups removed, the reactive functional groups of the linker molecules are made available for reaction with a subsequently added synthesis intermediate or other compound. The support is then washed or otherwise contacted with an additional synthesis intermediate that reacts with the exposed functional groups on the linker molecules to form a sequence. In this manner, a sequence of monomers of desired length can be created by stepwise irradiating the surface of the support to initiate a catalytic reaction to remove a protective group from a reactive functional group on a already present synthesis intermediate and then introducing a monomer, i.e. a synthesis intermediate, that will react with the reactive functional group, and that will have a protective group for later removal by a subsequent irradiation of the support surface.

Accordingly, a second set of selected regions on the support which may be the same or different from the first set of selected regions on the support is, thereafter, exposed to radiation and the removable protective groups on the synthesis intermediates or linker molecules are removed. The support is then contacted with an additional subsequently added synthesis intermediate for reaction with exposed functional groups. This process is repeated to selectively apply synthesis intermediates until polymers of a desired length and desired chemical sequence are obtained. Protective groups on the last added synthesis intermediate in the polymer sequence can then be optionally removed and the sequence is, thereafter, optionally capped.

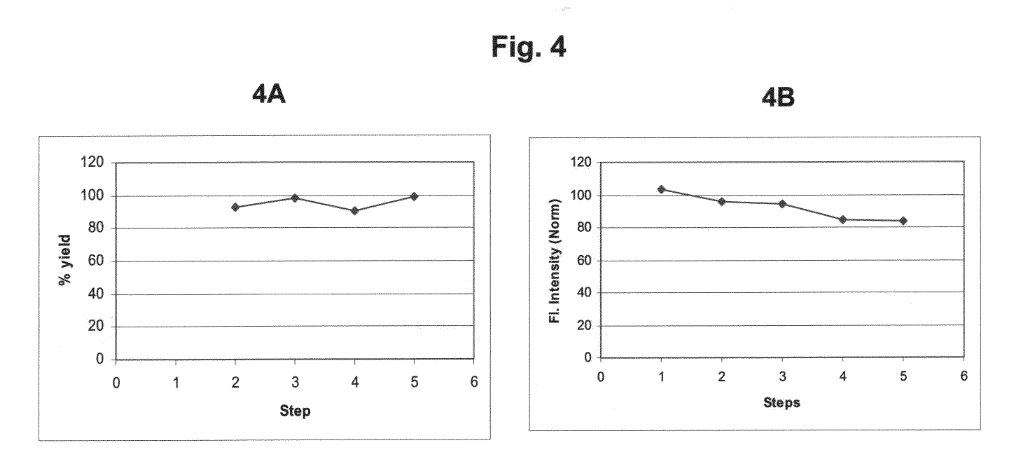

FIGS. 4A and B illustrate the stepwise in situ synthesis efficiency for the synthesis of a penta glycine peptide. FIG. 4A shows the step wise percentage yield for synthesizing a penta glycine peptide using the photoactive layer formulation with optimized resist at 50 mJ was about 96-98% at each step. FIG. 4B illustrates fluorescence intensity at each step.

In some instances, up to 20%, 30%, 40%, 50%, 60%, 70%, or 80% of the peptides on an array are the full-length of predetermined sequences. In some instances, up to 20%, 30%, 40%, 50%, 60%, 70%, or 80% of the peptides on an array are identical in sequence and length to predetermined sequences for such peptides.

### Generation of Arrays Using Electrochemical Means

In addition to photo acid generation, arrays can be constructed that allow for generation of acids through electrochemical means. High throughput synthesis of dense molecular arrays can be accomplished through the use of a solid phase catalytic or amplification layer and an array of electrodes. Electrochemical reactions generate a catalyst for protective group removal. A solid phase amplification layer that contains electro-active species is provided.

A feature of an array could contain an electrode to generate an electrochemical reagent, a working electrode to synthesize a polymer, and a confinement electrode to confine the generated electrochemical reagent. The electrode to generate the electrochemical reagent could be of any shape, including, for example, circular, flat disk shaped and hemisphere shaped.

A support or silicon wafer can consist of an array of electrodes that can be fabricated using semiconductor processing methods. A polymer building block having a protecting group is attached to the solid support through a linker molecule in a coupling reaction. As discussed more fully herein, in this example, the linker molecule serves to distance the polymer from the surface of the chip. In the case of peptide synthesis, the building block molecule is an amino acid that is protected by, for example, a tert-butoxycarbonyl group. The surface is initially treated with oxygen plasma to generate an oxidized metal surface and the linker is coupled to the oxidized surface. Alternately, the surface may be coated with a thin porous SiO2 layer and the linker attached through standard silane coupling chemistry. The surface is then coated with a thin solid-phase layer that is capable of generating an acid (H⁺, protons) when exposed to a voltage of about −2 V to about +2 V, i.e., an amplification layer. The solid phase amplification layer is composed of matrix polymer (such as, for example, PMMA) dispersed with electro-sensitizers (molecules commonly used as redox pairs belonging to the quinine family such as hydroquinone, benzoquinone). Optionally, the solid phase layer can also contain amplifier molecules (termed electro-acid amplifiers (EAA)) that can amplify the generation of protons from protons generated from electro-sensitizers. The solid phase amplification layer serves to cleave protecting groups; it can be activated causing the proximate solid phase layer to generate protons. The support is baked and the amplification layer is removed leaving two types of building blocks on the surface: the unmodified protected building block and the deprotected building block. A second building block is coupled to the deprotected first building block. This method can be repeated until the desired polymeric molecule(s) are synthesized on the support surface.

Similar approaches can be used for cleaving DMT (dimethoxytrityl) protecting groups for oligo nucleotide synthesis. Also, for base cleavable protecting groups such as F-moc groups, bases can be generated electrochemically along with base amplifiers (such as particular types of carbamates) in the solid phase layer for deprotection chemistry. This approach can also be used for small molecule synthesis (molecules having a molecular weight of less than about 800) generally done using principles currently applied in solution phase electrochemistry.

The polymer molecules can be built upon a support that contains an array of individually addressable electrodes. A protected spacer molecule is coupled to the surface of the support. By selectively activating regions of the array, the protected molecule attached to the surface is prepared for coupling a second molecule through the removal of its protecting group. A protected polymer building block is coupled to the deprotected surface-attached molecule. By repeatedly activating and deprotecting regions of the surface of the support building block molecules are coupled to the surface of the support in a spatially specific manner.

Electro-sensitizers (electroactive compounds) are compounds or molecules that can generate protons (H⁺) upon exposure to electrons. A chemical reaction may be used to generate protons in a solid-phase electroactive layer upon activation by an applied voltage. Electro-sensitizers that are dispersed in the solid phase amplification layer can be, for example, molecules commonly used as redox pairs belonging to the quinine family, such as, hydroquinone and benzoquinone.

Optionally, the amplification layer may also contain amplifier compounds that amplify the generation of protons from protons generated from electro-sensitizers (acid amplifier compounds). These amplifier molecules can be chosen from a class of molecules such as acid amplifiers (class of sulfonates undergoing autocatalytic fragmentation), photoacid generators such as, for example, onium salts such as diaryliodonium and triarylsulphonium salts, thermal acid generators, such as for example, 2,4,4,6-tetrabromocyclohexadienone, benzoin tosylate, 2-nitrobenzyl tosylate and other alkyl esters of organic sulfonic acids. The heat-catalyzed removal of a t-butyl group produces propene and protons.

The electrodes that may be used in embodiments of the invention may be composed of, but are not limited to, metals such as iridium and/or platinum, and other metals, such as, palladium, gold, silver, copper, mercury, nickel, zinc, titanium, tungsten, aluminum, as well as alloys of these metals, and other conducting materials, such as, carbon, including glassy carbon, reticulated vitreous carbon, basal plane graphite, edge plane graphite, and graphite. Doped oxides such as indium tin oxide, and semiconductors such as silicon oxide and gallium arsenide are also contemplated. Additionally, the electrodes may be composed of conducting polymers, metal doped polymers, conducting ceramics and conducting clays.

The electrode(s) may be connected to an electric source in any known manner. For example, connecting the electrodes to the electric source may include CMOS (complementary metal oxide semiconductor) switching circuitry, radio and microwave frequency addressable switches, light addressable switches, direct connection from an electrode to a bond pad on the perimeter of a semiconductor chip, or combinations thereof. CMOS switching circuitry involves the connection of each of the electrodes to a CMOS transistor switch. The switch could be accessed by sending an electronic address signal down a common bus to SRAM (static random access memory) circuitry associated with each electrode. When the switch is on, the electrode is connected to an electric source. Radio and microwave frequency addressable switches involve the electrodes being switched by a RF or microwave signal. This allows the switches to be thrown both with and/or without using switching logic. The switches can be tuned to receive a particular frequency or modulation frequency and switch without switching logic. Light addressable switches are switched by light. In this method, the electrodes can also be switched with and without switching logic. The light signal can be spatially localized to afford switching without switching logic. This could be accomplished, for example, by scanning a laser beam over the electrode array; the electrode being switched each time the laser illuminates it.

The generation of and electrochemical reagent of a desired type of chemical species requires that the electric potential of the electrode that generates the electrochemical reagent have a certain value, which may be achieved by specifying either the voltage or the current. The desired potential at an electrode may be achieved by specifying a desired voltage value or the current value such that it is sufficient to provide the desired voltage. The range between the minimum and maximum potential values is determined by the type of electrochemical reagent chosen to be generated.

A wafer is a semiconductor support. A wafer could be fashioned into various sizes and shapes. It could be used as a support for a microchip. The support could be overlaid or embedded with circuitry, for example, a pad, via, an interconnect or a scribe line. The circuitry of the wafer could also serve several purposes, for example, as microprocessors, memory storage, and/or communication capabilities. The circuitry can be controlled by the microprocessor on the wafer itself or controlled by a device external to the wafer.

A via interconnection refers to a hole etched in the interlayer of a dielectric which is then filled with an electrically conductive material, for example, tungsten, to provide vertical electrical connection between stacked up interconnect metal lines that are capable of conducting electricity. A scribe line is typically an inactive area between the active dies that provide area for separating the die. Often metrology and alignment features populate this area.

Array chips on silicon wafers can be built using silicon process technology and SRAM like architecture with circuitries including electrode arrays, decoders, and serial-peripheral interface, for example. Individually addressable electrodes can be created with CMOS circuitry. The CMOS circuitry, among other functions, amplifies the signal, and reads and writes information on the individually addressable electrodes. A CMOS switching scheme can individually address different working electrodes on a wafer. Each die pad on the die can branch into a large array of synthesis electrodes. CMOS switches ensure that a given electrode (or an entire column, or an entire row) can be modified one base pair at a time.

Voltage source and counter electrode (plating tool) are shown to complete the electrical circuit. The electrodes of the array can electrically connect through a CMOS switch through a bonding pad to a voltage source. A counter electrode is also supplied. With this scheme, and electrode can be individually activated. The bonding pad is used, for example, for power and signal delivery. The die pads can be interconnected by either using a multilevel interconnect (two or more layers) across a scribe line on the front side of the wafer or by using a via interconnect that traverses from the front side of the wafer to the backside of the wafer.

The use of photolithography, e.g., with photoresist and RAC, or the other manufacturing means described herein, allows for arrays that provide that each polymer or peptide with a distinct sequence can be synthesized within a feature with an area between 0.2 to 100 um², 0.2 to 10 um², 0.2 to 1 um², 0.2 to 0.5 um², or in an area of up to 0.5, 1, 5, 10, 15, 20, 25, 50, 100, 250, 500, 1000 um².

The arrays of the present invention have several advantageous features. The arrays are made using a scalable process using standard semiconduct fabrication tools. Each process step is precisely controlled and reproducible, resulting in a robust array. Array synthesis is highly automated and optimized to significantly reduce process variation. The peptide arrays of the present invention allow high-throughput use, can be reliable, and can be cost-efficient.

Alternative embodiments to the methods described above for generating peptide array using photoresist-RAC may be found in, for example, U.S. Pat. Nos. 6,083,697 and 6,770,436 to Beecher et al. and U.S. Patent Application Publication Nos. 2007/0154946 (filed on Dec. 29, 2005), 2007/0122841 (filed on Nov. 30, 2005), and 2007/0122842 (filed on Mar. 30, 2006).

### Characteristics of the Peptide Arrays

The peptide arrays of the present invention can include any one or more of the characteristics described herein, and such arrays can be manufactured using any of the means described herein.

Peptide Arrays with Enzyme Substrates

In some instances, a peptide array of the present invention, e.g., one constructed using photolithography comprises peptides that are enzyme substrates. Thus, a subset of the peptides on the array or all of the peptides on the array may be enzymatic substrates.

The enzymatic substrates (e.g., peptides) on the array can be physiological (naturally occurring sequences), artificial, or a combination thereof. Examples of physiological peptides include peptide substrates that are naturally occurring or a fragment of a physiological protein. Examples of artificial peptides can include randomly synthesized peptides, peptides designed based on physiological substrates, and peptides designed based on the structure or known binding of enzymes. In some embodiments, the peptide array can be a mix of artificial and physiological substrates.

A peptide array can be designed to provide specific information about the enzymes for the user. For example, a peptide array can provide information on all known enzymes, all enzymes of a specific class (e.g., kinases, or hydrolases, such as phosphatases, and proteases), all known enzymes in a specific pathway(s) (e.g., PKC, p53, TRAIL, TNFR1, and JNK), or all known substrates of a single enzyme.

Alternatively, information can be provided for a subset of enzymes in a specific class (for example, a specific kinase family such as casein kinases or AGC kinases), a subset of enzymes in a pathway, or a subset of substrates of an enzyme. In some instances, a peptide array comprises a plurality of peptides that collectively represent all known physiological kinase substrates for a specific kinase, e.g., ATM. In another embodiment, a peptide array comprises a plurality of peptides that collectively represent all physiological substrates for an entire class of enzymes, e.g., serine phosphatases. For example, the peptide array can comprise protease or phosphatase substrate peptides for at least 50%, 90%, 99%, or all of the phosphatase substrates, or kinase substrates of an organ or organism. Furthermore, the peptide array can comprise kinase substrate peptides for at least 50%, 90%, 99%, or all of the kinase substrates an organ or an organism, for example, kinase substrates for the kinome of an organism, such as publicly available at www.kinase.com/mammalian.

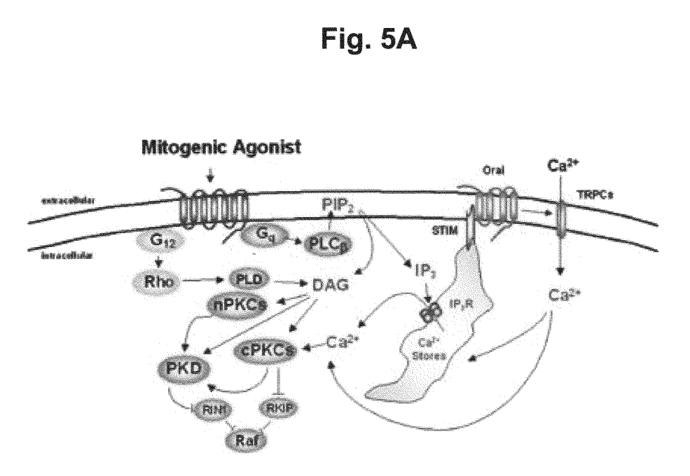

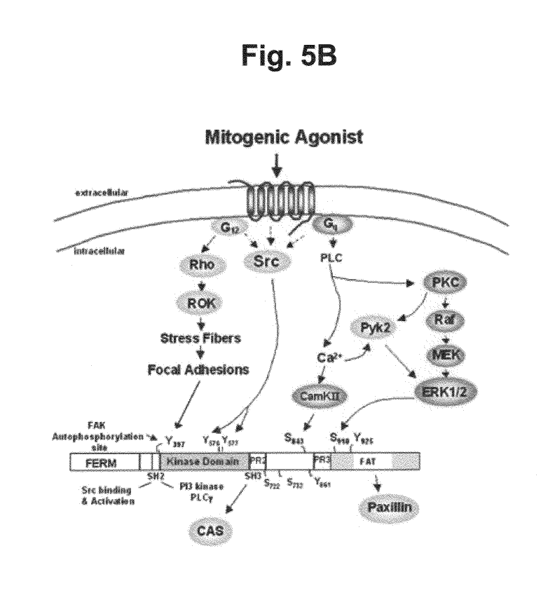

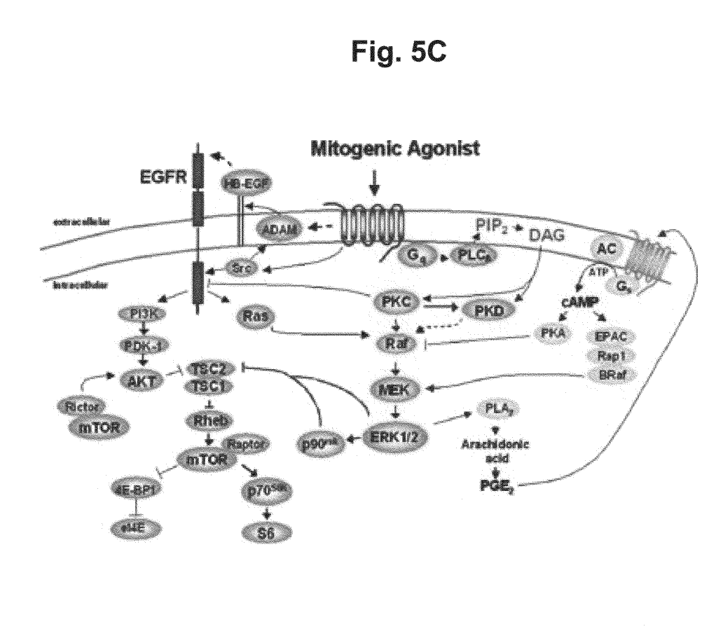

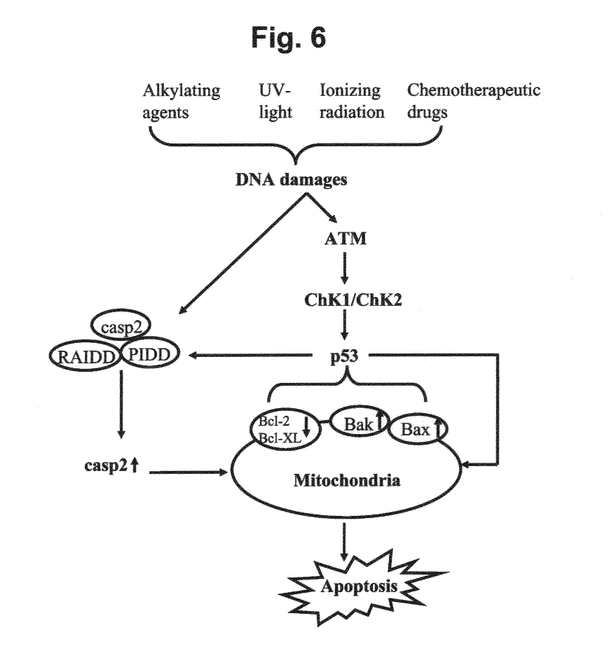

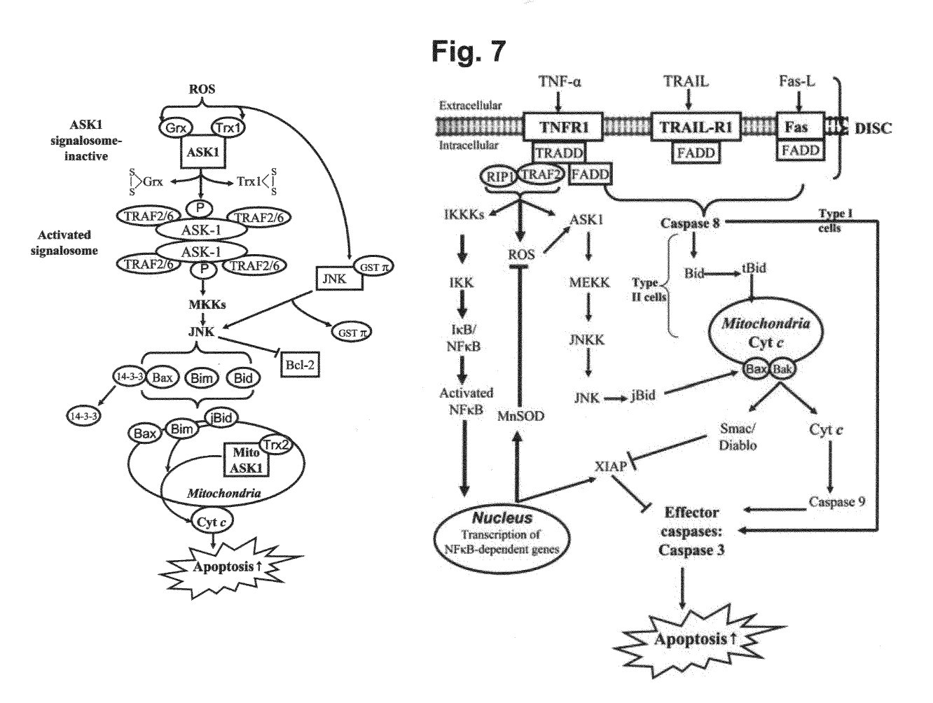

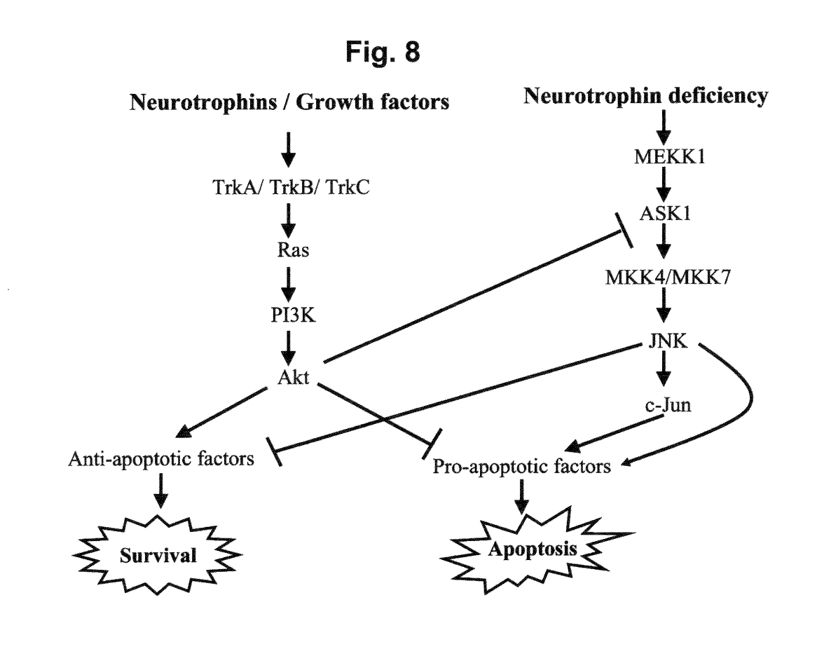

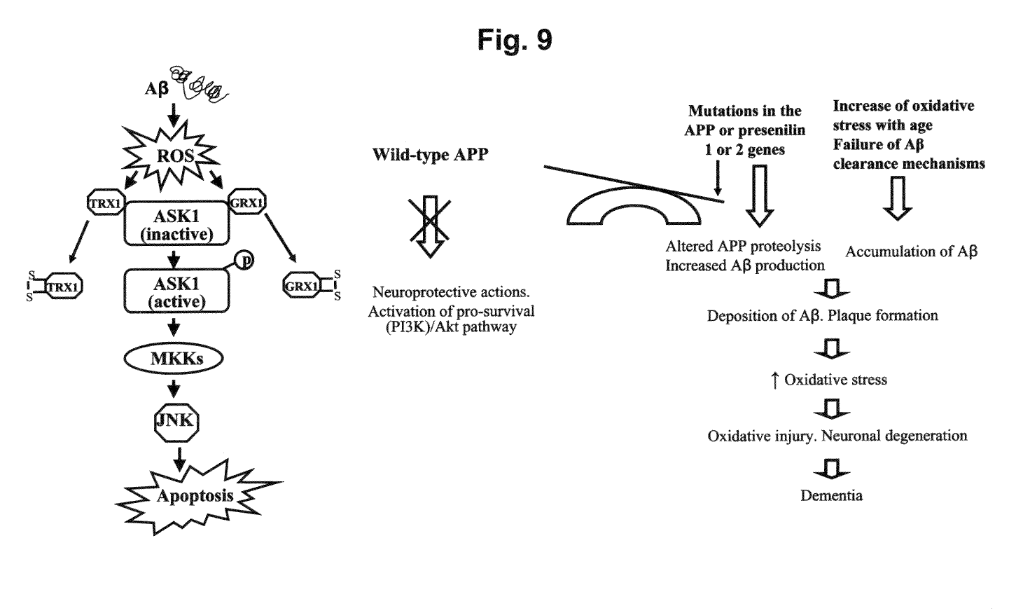

At least a subset or all peptides on a peptide array of the present invention can be substrates for enzymes in a biological pathway. For example, at least a subset of peptides on a peptide array can be substrates of enzymes in DNA damage signaling pathways. Other biological pathways whose substrates can be represented on an array can include apoptosis signaling pathways, G protein-coupled receptor (GPCR) signaling pathway, or pathways involved in diseases or conditions, such as a disease associated with apoptosis, a disease associated with signal transduction pathways of GPCRs, cancer, inflammation, neurodegenerative diseases, and Alzheimer's disease. For example, the peptides on the array can be peptides or peptide fragments of molecules involved in physiological cellular process, such as in signaling pathways involved in GPCR signaling (for example, as seen in FIGS. 5A-C), or peptides that represent sequences of proteins that are downstream of a G-protein coupled receptor. In other embodiments, a peptide array comprises substrates that are peptides or peptide fragments of molecules involved in DNA damage signaling (for example, in FIG. 6), apoptosis (for example, FIG. 7), or peptides or peptide fragments of proteins involved in cancer, inflammation, or neurodegenerative diseases (for example, in FIG. 8), and Alzheimer's (for example, in FIG. 9).

A peptide array can comprise peptides that are substrates for hydrolases. For example, an array can have at least a subset of its peptides be substrates of esterases such as nucleases, phosphodiesterases, lipases, phosphatases, glycosylases, etherases, proteases, or acid anhydride hydrolases, (e.g. helicases and GTPases). Other hydrolases whose substrates can be found on a peptide array of the invention include enzymes that hydrolyze ether bonds, non-peptide carbon-nitrogen bonds, halide bonds, phosphorus-nitrogen bonds, sulfur-nitrogen bonds, carbon-phosphorus bonds, sulfur-nitrogen bonds, carbon-phosphorus bonds, sulfur-sulfur bonds, and carbon-sulfur bonds. Additional examples of hydrolases include acetylesterase, thioesterase, and sulfuric ester hydrolases.

In one embodiment, a set of peptides on an array can include protease sites for at least 50% of all the proteases of a protease family. In another embodiment, a set of peptides on an array can comprise protease sites for at least 50% of all the proteases of an organ or organism. In another embodiment, a set of peptides on an array can include protease sites for at least 50% of all the proteases of the liver, kidney, or heart. A set of peptides on an array can include protease sites for at least 50% of all the proteases of a eukaryote or prokaryote. A set of peptides on an array can include protease sites for at least 50% of all the proteases of a human.

In one embodiment, the present invention contemplates a peptide array produced by photolithography using any of the means described herein, wherein the array comprises a plurality of peptides that are protease substrates. The proteases that these peptides act as substrates to include serine proteases, threonine proteases, cysteine proteases, aspartic acid proteases, metalloproteases, and glutamic acid proteases. Substrates to proteases such as those described in the peptidase database, http://merops.sanger.ac.uk/ can be used in the present invention.

Examples of phosphatases whose substrates can be generated as natural or artificial peptides include tyrosine-specific phosphatases, serine/threonine specific phosphatases, dual specificity phosphatases, histidine phosphatases, and lipid phosphatases. Additional phosphatases whose substrates can be inserted into any of the peptide arrays herein include those described in the kinase-phosphatase database, http://www.proteinlounge.com/kinase_phosphate.asp. For example, substrates to alkaline phophastase and/or PP2A can be provided on any of the peptide arrays described herein.

The peptide arrays can also comprise substrates for kinases, such as kinases described in the kinase-phosphatase database, http://www.proteinlounge.com/kinase_phosphate.asp, or the human kinome, for example at www.kinase.com/mammalian.

The peptides on a peptide array can be organized in peptide clusters. The peptide array can have at least a subset of peptides form one or more peptide clusters, or all of the peptides form one or more peptide clusters. Each peptide in a peptide cluster can be the same or different.

A peptide array can have at least 1, 2, 5, 10, 20, 50, 75, 100, 1000, or 10,000 peptide clusters. The number of different peptides (or features) in a cluster can be from 2 to 100,000,000. In some embodiments, a cluster has at least 3, 4, 5, 6, 7, 8, 9, 10, 11, 12, 13, 14, or 15 different peptides (or features). In other embodiments, the peptide cluster has hundreds or thousands of different peptides (or features), for example at least 100, 200, 300, 500, 1000, 1500, 2000, 5000, 10,000, 15,000, or 150,000 different peptides (or features). Each of the features can have a different peptide sequence, or a subset of the features have the same peptide sequence.

In some embodiments, the different peptides (or features) within a peptide cluster all comprise peptides with one or more enzymatic reaction sites. For example, all peptide clusters include different peptides with hydrolase sites, such as a site for a phosphatase or protease, to dephosphorylate or cleave the peptide, respectively, or phosphorylation sites to phosphorylate the peptide. In some embodiments, each peptide may have a single enzymatic reaction site. The enzymatic reaction site can be the same for all different peptides in the cluster. For example, a peptide substrate cluster can have 10,000 different peptides each with a phosphorylation site. The peptide sequence of a peptide may be the same, or different, monomer sequence as the peptide sequences of other peptides in the peptide cluster.

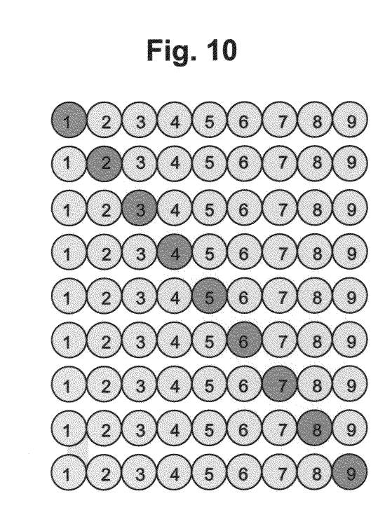

A peptide array can also comprise a peptide cluster wherein each peptide of the peptide cluster comprises an enzymatic reaction site, such as a hydrolase or phosphorylation site, at a different position in the peptide sequence. For example, the enzymatic site of peptides within in a feature is at a different position than the monomer sequence of peptides in another feature within the same peptide cluster, wherein the remaining sequence of the peptides in both features is identical to a single predetermined sequence (see FIG. 10). A peptide cluster such as described above, for example, can comprise at least 9 features, wherein each feature comprises a peptide sequence different than the other. Each row of monomers as shown in FIG. 10 represents the peptide sequence of a given feature. The predetermined sequence is identical with the exception of the amino acid sequence shift of one, from one peptide sequence in to another peptide sequence. The single enzymatic reaction site is shown as a single dark. The enzymatic reaction site is in a different position in each of the 9 monomer sequences. The remaining monomers are the same for each of the peptides, and this peptide substrate cluster of 9 different monomer sequences. Variations of this substrate peptide cluster is obvious to one of ordinary skill in the arts, for example, substrate clusters with less than 9 monomer sequences, such as a cluster with 5 peptide sequences, the peptides being 5 monomers long, and the peptide sequence differing from others within the peptide cluster by one amino acid shift. In other embodiments, the substrates clusters have monomer sequences at least 9, 10, 11, 12, 13, 14, 15, 18, or 20 monomers long, with the corresponding number of unique peptide sequences and features in a peptide cluster. In some embodiments, the features are up to 1 um² and the peptide arrays comprise at least 1000, 2000, 3000, 4000, or 5000 features. Each of the features can have a unique peptide sequence, or a subset of the features have the same peptide sequence. It is well known to one of skill in the arts, enzymatic reactions sites can encompass any sites recognized by an enzyme, and variations of the peptide clusters, for example, the number of monomers of a peptide, the number of peptide sequences in the cluster, and the variations of predetermined sequences can be designed. The peptide clusters can be used to determine the ideal in vitro substrate for an enzyme, for example, the best in vitro kinase substrate.

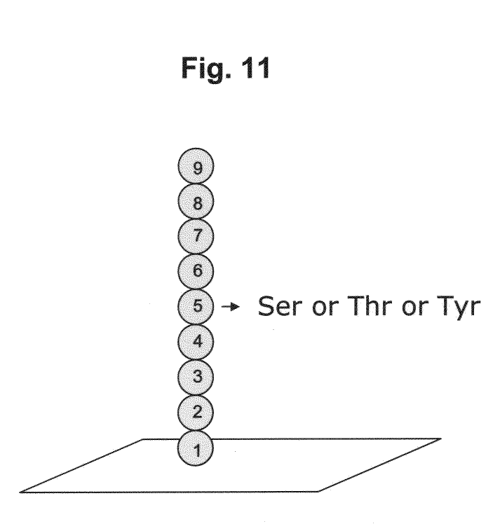

In other embodiments, the single enzymatic reaction site can be in the same monomer position as all the other peptide sequences in a peptide cluster, for example, as seen in FIG. 11, wherein the single enzymatic reaction site is a phosphorylation site, such as Ser, Thr, or Tyr, in position 5. The remaining monomer positions for example in positions 1 to 4, and 6 to 9, can be any amino acid. The number of unique peptide sequences in this embodiment can encompass all the different variations. In other embodiments, the enzymatic reaction site can be a hydrolase site, such as a protease or phosphatase site. In other embodiments, each peptide in a cluster has at least 9, 10, 11, 12, 13, 14, 15, 18, or 20 monomers. In some embodiments, the features are up to 1 um² and the peptide arrays comprise at least 1000, 2000, 3000, 4000, or 5000 features. Each of the features can have a unique peptide sequence, or a subset of the features have the same peptide sequence. It is well known to one of skill in the arts, enzymatic reactions sites can encompass any sites recognized by an enzyme, and variations of the peptide clusters, for example, the number of monomers of a peptide, number of peptides in the cluster, and the number of variations for random amino acids in the monomer positions not encompassing the enzymatic reaction site can be designed. The peptide clusters can be used to determine the ideal in vitro substrate for an enzyme, for example, the best in vitro kinase substrate.

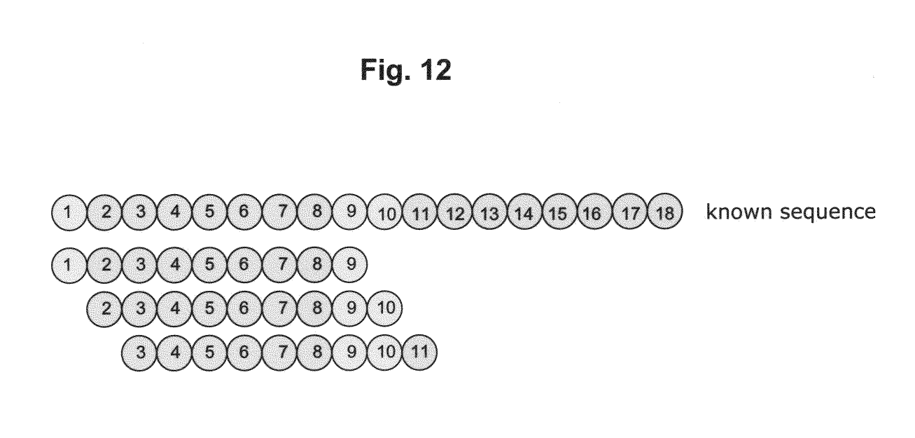

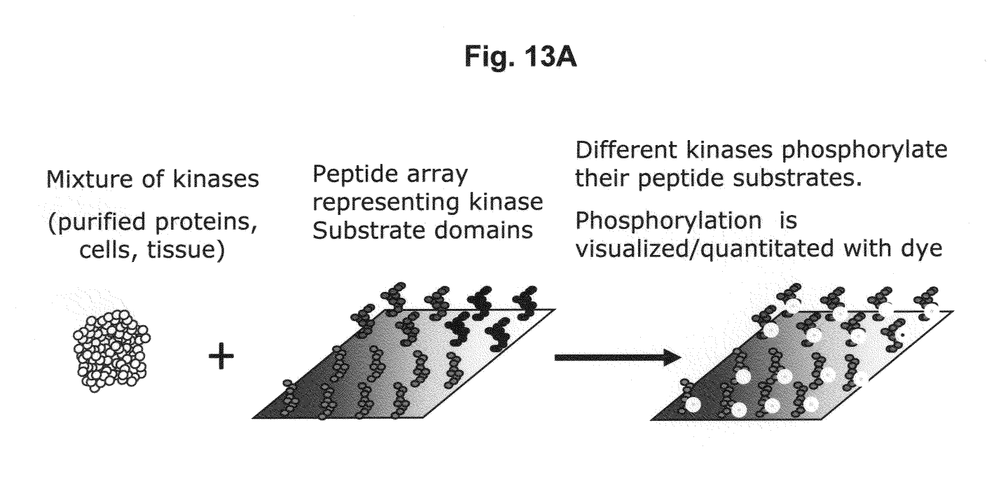

In other embodiments, the peptide sequences in a peptide cluster are derived from a protein sequence, wherein each peptide sequence overlaps with another peptide sequence in the substrate cluster, such that each peptide sequence is a portion or fragment of a common or known protein sequence (e.g. FIG. 12). The known protein sequence has at least one reaction site. In some embodiments, the known protein sequence has at least 2, 3, 4, 5, 6, 7 or 8 reaction sites. The reaction sites can be a hydrolase site, such as a protease or phosphatase site, or a phosphorylation site. The known protein sequence can also have a mixture of enzymatic reactions sites, for example, both protease and phosphorylation sites. The peptide sequences that are derived from the known protein sequence can have no reaction sites, at least 1 reaction site, or at least 2, 3, 4, 5, 6, 7 or 8 reaction sites. The overlap of monomers between the peptide sequences can be at least 1 monomer, or at least 2, 3, 4, 5, 6, 8, 9, 10, 11, 12, 13, 14, 15, 16, 17, 18, or 19 monomers. The number of unique peptide sequences in this embodiment can encompass coverage of the entire common protein sequence, or a portion of the entire common protein sequence. The substrates clusters can have monomer sequences at least 9, 10, 11, 12, 13, 14, 15, 18, or 20 monomers long, with the corresponding number of unique peptide sequences and features in a peptide cluster. In some embodiments, the features are up to 1 um² and the peptide arrays comprise at least 1000, 2000, 3000, 4000, or 5000 features. Each of the features can have a unique peptide sequence, or a subset of the features have the same peptide sequence. It is well known to one of skill in the arts, enzymatic reactions sites can encompass any sites recognized by an enzyme, and variations of the peptide clusters, for example, the number of monomers of a peptide, number of peptides in the cluster, and the number of variations for the peptide sequences will vary depending on the common protein sequence. The peptide clusters can be used to map the position of the enzymatic site for a given enzyme.

Peptide arrays with kinase substrates can be used for drug development. Samples from targeted tissues/cells can be applied to a peptide array with kinase substrates, and the phosphorylation of substrates can reveal a “kinase activity fingerprint”. Peptide substrate phosphorylation and a “kinase activity fingerprint” can be used to yield information on target validation, hits/leads generation, lead optimization, preclinical animal studies (pharmacokinetic (PK), pharmacodynamic (PD) and toxicity), and Phase I/II/III clinical trials. Peptide substrate phosphorylation can also be used to study side effects of treatments on organs (e.g. heart, kidney, or liver).

The present invention also provides peptide arrays and uses of peptide arrays in research applications and diagnostics.

Peptide Arrays with Peptides from Proteomes

The arrays of the present invention can contain at least a set of peptides that cover an entire proteome (set of proteins expressed by a genome) of a cell, tissue, organ, or organism. The sets of peptides can cover the proteome on a single chip or on more than one chip. The sets of peptides that comprise the entire proteome can be on at least 1, 2, 3, 4, 5, 6, 7, 8, 9, or 10 chips. The number of chips needed to cover the entire proteome can be dependent on the number of features on the chips.

The organism can be a eukaryote or a prokaryote. The organism can be an animal, plant, or fungus. The organism can be a human or yeast. The peptide array can contain all the antigenic peptides from a human proteome. The organism can be an infectious agent, a bacterium, a microorganism. The sequence of the peptides from a proteome can overlap and can be antigenic. A set of peptides on the array can have an amino acid shift of one amino acid position with respect to at least one other peptide. A set of peptides can have a sequence that overlaps with another peptide by at least 1, 2, 3, 4, 5, 6, 7, 8, 9, 10, 11, 12, 13, 14, 15, 16, 17, 18, or 19 amino acids. Peptides from proteomes of different species can be on the same peptide array. The peptides on the array can be clustered based on whether the organisms belong to separate families.

Peptides on an array of the present invention can be from animal organs, including the heart, liver, kidney, brain, skin, lung, stomach, pancreas, intestines, urinary bladder, uterus, testicles, or spleen. Peptides on an array of the present invention can be from animal tissues include, but are not limited to, epithelium, connective tissue, muscle tissue, and nervous tissue.

A set of peptides on an array of the present invention can be derived from vegetative plant organs include root, stem, and leaf. A set of peptides on an array of the present invention can be from reproductive plant organs include flower, seed, and fruit. A set of peptides on an array of the present invention can be from plant tissue includes epidermis, vascular tissue, and ground tissue.

The arrays of the present invention can contain at least a set of peptides that cover an entire proteome of a cell, tissue, organ, or organism can contain at least 10,000 features, individual features with an area up to 35 um², or have peptides with up to 500 monomers.

The peptides on a peptide array can include at least 4, 5, 6, 7, 8, 9, 10, 11, 12, 13, 14, 15, 16, 17, 18, 19, or 20 monomers. Peptides on an array can have 6-150 monomers, 6-500 monomers, 3-35 monomers.

The peptides on a peptide array can include at least 10,000, 50,000, 500,000, 1,000,000, 2,000,000, 3,000,000, 10,000,000, 20,000,000 or 100,000,000 different peptides.

A set of peptides on an array can contain predicted MHC class I or MHC class II binding peptides of an organ or organism. A peptide sequence can be a predicted to be an MHC class I or MHC class II binding peptide by a computer program. A peptide sequence can be predicted to be an MHC class I or MHC class II binding peptide by an experiment. A peptide sequence can be predicted to be an MHC class I or MHC class II binding peptide by visual inspection. A predicted MHC class II binding peptide can be 10-30 monomers long. A predicted MHC class II binding peptide can be at least 10, 11, 12, 13, 14, 15, 16, 17, 18, 19, 20, 21, 22, 23, 24, 25, 26, 27, 28, 29, or 30 amino acids long. Methods of predicting MHC class II peptides are known by those skilled in the art.

Peptide Arrays with Peptides from Oncogenes

An array of the present invention can contain peptides with sequences from known oncogenes. Examples of oncogenes include MYC, RAS, WNT, ERK, SRC, ABL, BCL2, and TRK. Additional oncogenes include v-myc, N-MYC, L-MYC, v-myb, v-fos, v-jun, v-ski, v-rel, v-ets-1, v-ets-2, v-erbA1, v-erbA2, BCL2, MDM2, ALL1(MLL), v-sis, int2, KS3, HST, EGFR, v-fms, v-KIT, v-ros, MET, TRK, NEU, RET, mas, SRC, v-yes, v-fgr, v-fes, ABL, H-RAS, K-RAS, N-RAS, BRAF, gsp, gip, Dbl, Vav, v-mos, v-raf, pim-1, v-crk. Oncogenes are disclosed in Croce, “Oncogenes and Cancer”, The New England Journal of Medicine, 358; 502-511 and supplemental information (2008). The peptides of arrays of the present invention can cover the full-length sequence of known oncogenes. The peptides from known oncogenes on the array can also overlap in their sequence as is illustrated in FIG. 12. A set of peptides on the array can have an amino acid shift of one amino acid position with respect to at least one other peptide. A set of peptides can have a sequence that overlaps with another peptide by at least 1, 2, 3, 4, 5, 6, 7, 8, 9, 10, 11, 12, 13, 14, 15, 16, 17, 18, or 19 amino acids. The peptides on the array can comprise the entire sequence of 10%, 50%, 90%, or all proteins encoded by oncogenes. The peptides on a peptide array can include at least 4, 5, 6, 7, 8, 9, 10, 11, 12, 13, 14, 15, 16, 17, 18, 19, or 20 monomers. Peptides on an array can have 6-150 monomers, 6-500 monomers, 3-35 monomers.

The peptides on a peptide array can include at least 10,000, 50,000, 500,000, 1,000,000, 2,000,000, 3,000,000, 10,000,000, 20,000,000 or 100,000,000 different peptides.

The sequence of the peptides from oncogenes can be antigenic. A set of peptides on an array can contain predicted MHC class I or MHC class II binding peptides from proteins encoded by oncogenes. A peptide sequence can be a predicted to be an MHC class I or MHC class II binding peptide by a computer program. A peptide sequence can be predicted to be an MHC class I or MHC class II binding peptide by an experiment. A peptide sequence can be predicted to be an MHC class I or MHC class II binding peptide by visual inspection of the sequence. A predicted MHC class II binding peptide can be 10-30 monomers long. A predicted MHC class II binding peptide can be at least 10, 11, 12, 13, 14, 15, 16, 17, 18, 19, 20, 21, 22, 23, 24, 25, 26, 27, 28, 29, or 30 amino acids long. Methods of predicting MHC class II peptides are known by those skilled in the art.

Peptide Arrays with Peptides for the Study and Diagnosis of Autoimmune Disorders

Peptide arrays can be made from known antigens that elicit autoantibodies in patients with an autoimmune disease. These arrays can be used for research applications or to diagnose autoimmune disorders. Examples of autoimmune diseases include acute disseminated encephalomyelitis, Addison's disease, ankylosing spondylitis, antiphospholipid antibody syndrome, aplastic anemia, autoimmune hepatitis, autoimmune oophoritis, celiac disease, Crohn's disease, diabetes mellitus type 1, gestational pemphigoid, Goodpasture's syndrome, Graves' disease, Guillai-Barre syndrome, Hashimoto's disease, idiopathic thrombocytopenic purpura, Kawasaki's disease, systemic lupus erythematosus, mixed connective tissue disease, multiple sclerosis, myasthenia gravis, opsoclonus myoclonus syndrome, optic neuritis, Ord's thyroiditis, pemphigus, pernicious anaemia, polyarthritis, primary biliary cirrhosis, rheumatoid arthritis, Reiter's syndrome, Sjogren's syndrome, Takayasu's arteritis, temporal arteritis, warm autoimmune hemolytic anemia, and Wegener's granulomatosis.

Examples of antigens that elicit autoantibodies in autoimmune disorders have been described in the literature. For instance, in rheumatoid arthritis, antigens that elicit autoantibodies include La, Hsp65, Hsp70, type II collagen, hnRNP-B1, CCP, and Ro/La. Antigens eliciting autoantibodies in multiple sclerosis include myelin oligodendrocyte glycoprotein (MOG), myelin basic protein (MBP), protelipid protein (PLP), oligodendrocyte-specific protein (OSP), and myelin-associated glycoprotein (MAG). Antigens in autoimmune thyroid disease include thyroglobulin, TSH receptor, and thyroid peroxidase. Thus, a peptide array can be made using any of the methods herein to include a number of peptide clusters. The peptides on the array can comprise the entire sequence of 50%, 90%, or all proteins encoded by antigens that elicit an antibody response in subjects with an autoimmune disease.

Peptide Arrays with Peptides for Research and Diagnostic Applications Related to Viruses

In other embodiments, the peptide array contains peptides with sequences from viral proteins. The viral proteins may be viral envelope proteins from a viral family or from all viruses. The peptide sequences may overlap. In addition, the peptides on the array may be antigenic peptides covering multiple viral proteins, proteins from a viral family, or proteins from all viruses. Viral proteins can include viral envelope proteins and viral coat proteins, for example. Examples of virus families include, for example, adenovirus, iridovirus, herpesvirus, papovavirus, parvovirus, poxvirus, coronavirus, orthomyxovirus, paramyxovirus, picornavirus, retrovirus, and rhabdovirus.

The peptides on the array can comprise the entire sequence of 50%, 90%, or all of the sequences of all viral envelope proteins of a viral family or all viruses. The peptides on the array can comprise 50%, 90%, or all of the sequences of overlapping antigenic peptides covering all viral proteins of a viral family or all viruses.

The peptide arrays can also be made from peptide sequences from viruses that can be used as bioterrorism agents, such as Variola major virus, which causes small pox; encephalitis viruses, such as western equine encephalitis virus, eastern equine encephalitis virus; and Venezuelan equine encephalitis virus, arenaviruses, bunyaviruses, filoviruses, and flaviviruses

Peptide Arrays with Peptides from Non-Viral Infectious Agents

Peptide arrays can also be made using peptide sequences from other infectious agents or pathogens, including, for example, bacteria, fungi, protozoa, multicellular parasites, and other microoraganisms. The peptides can be from prions. The peptide sequences can be from proteins from bacteria that include, for example, Bacillus anthracis, Neisseria meningitidis, Streptococcus pneumoniae, Staphylococcus aureus, Listeria monocytogenes, Haemophilus influenzae, Mycobacterium tuberculosis, Pseudomonas aeruginosa, Clostridium botulinum, Brucella abortus, or other bacteria.

Peptide Arrays with Peptides with Random Sequences

Peptide arrays with random peptide sequences can be made. The peptides with random sequence can be grouped into sub-libraries based on the frequency with which they are present in a given proteome. For instance, the 100, 200, 1000, or 10,000 most commonly occurring sequences of 6-150 amino acids in the human proteome can be synthesized as peptides on an array. The 100, 200, 1000, or 10,000 least commonly occurring sequences of 6-150 amino acids in the human proteome can be synthesized as peptides on an array.

### Use of Peptide Arrays for Research Applications

Any of the peptides arrays described herein can be used as a research tool. In one aspect of the invention, peptides arrays are used for high throughput screening assays. For example, enzyme substrates (i.e. peptides on a peptide array described herein) can be tested by subjecting the peptide array to an enzyme and identifying the presence or absence of enzyme substrate(s) on the array. Identifying the peptide can be by detecting at least one change in said at least one peptide. More than one change can also be identified.

The change detected can be any enzymatic reaction or process, for example hydrolysis, proteolysis, dephosphorylation, phosphorylation or complex formation between the enzyme and one or more of the substrates on the array. Complex formation can also be used to determine the binding specificity of the enzyme.

Enzymatic activity can be determined by various means. For example, enzyme activity can be determined by applying the enzyme to a peptide array described herein and determining a profile or signature of enzymatic activity across a broad spectrum of substrates.

Enzymes screened or tested, or used for determining activity, can be from cell lysates or purified proteins. Enzymes can be from prokaryotic or eukaryotic cells. The enzymes can be purified proteins produced by recombinant means or endogenous proteins. The enzymes can be any enzyme known in the art, for example hydrolases or kinases.

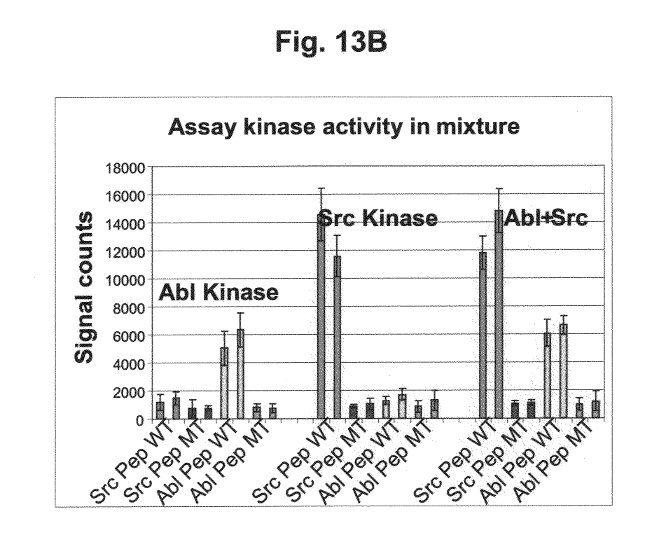

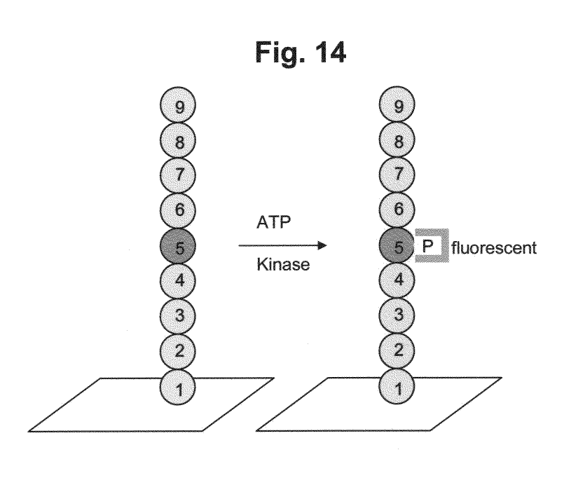

Kinases can be screened using the peptide array. For example, as shown in FIGS. 13A and B, enzymes such as a mixture of kinases, or a single kinase, can be applied to a peptide array representing kinase substrates. The substrates that are phosphorylated can then be detected. Detection can be by fluorescence (see FIG. 14), for example, by using commercially available reagents such as ProQ Diamond (Invitrogen, CA). Binding assays can also be used with kinases and peptide arrays, wherein either the kinase or the peptide is labeled, and binding affects the level of fluorescence. Many tags are available for labeling, for example, including, but not limited to, fluorescein, eosin, Alexa Fluor, Oregon Green, Rhodamine Green, tetramethylrhodamine, Rhodamine Red, Texas Red, coumarin and NBD fluorophores, QSY (Invitrogen), dabcyl and dabsyl chromophores and biotin, as well as antigens or antibodies. Phosphorylation can also be detected by mass spectrometry. Mass spectrometry can include tandem mass spectrometry (MS/MS), matrix-assisted laser desorption source with a time-of-flight mass analyzer (MALDI-TOF), and liquid chromatography/mass spectrometry (LC/MS). Phosphorylation can be detected using labeled ATP, such as radiolabeled ATP. Antibodies specific for phosphorylation can also be used for detection, or used to detect the bound kinase.

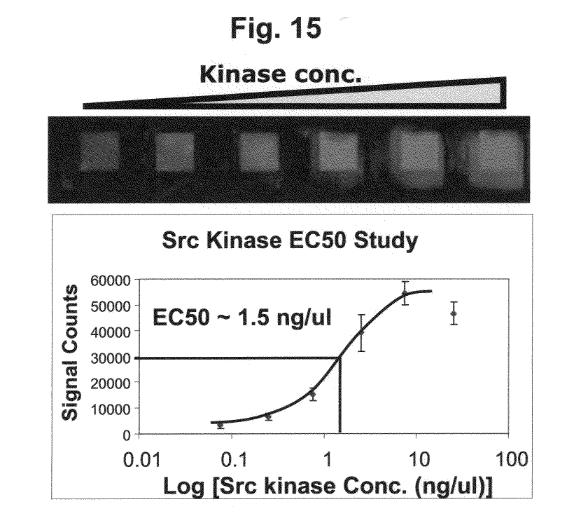

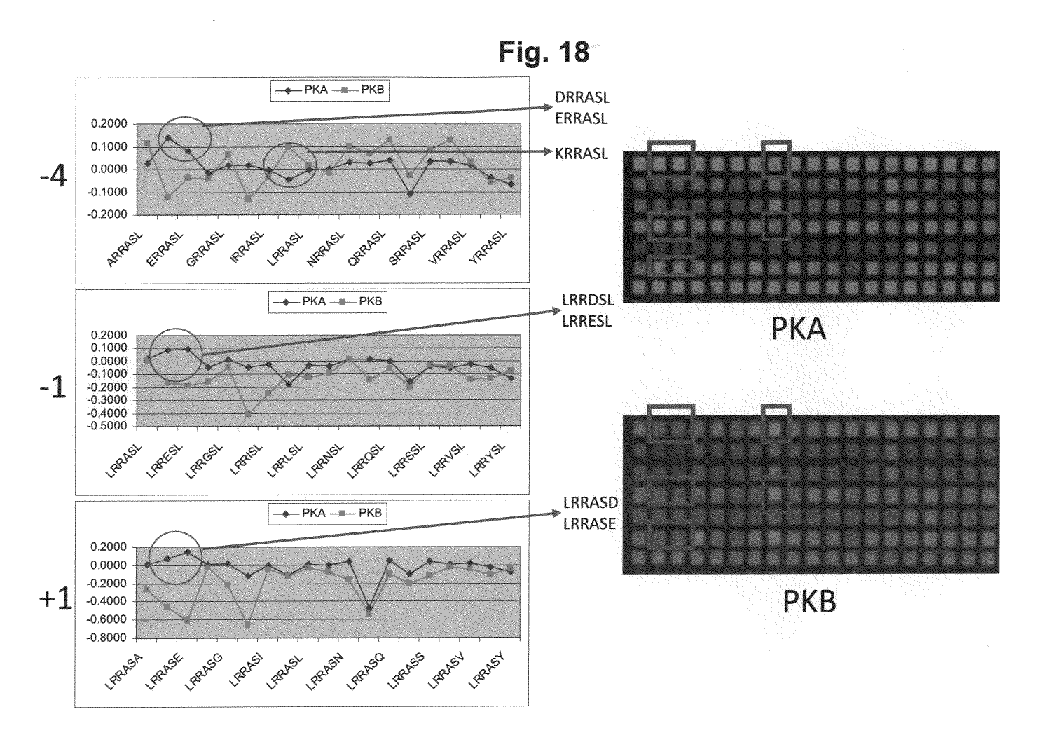

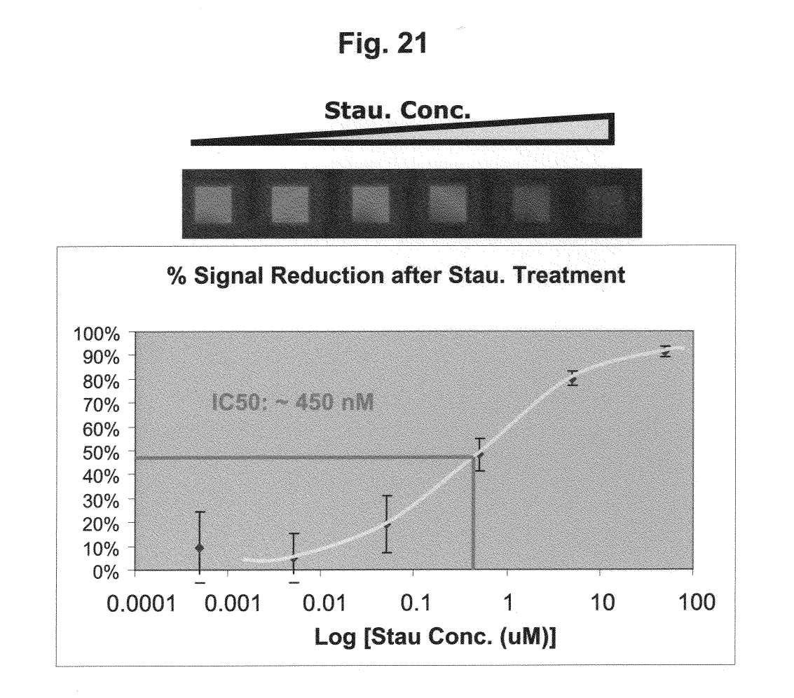

Identified peptides can serve as a tool to identify in vivo substrates of the kinase or as possible drugs for the kinase. For example, EC50 or substrate specificity can be determined by screening the kinases with a peptide array (see for example, FIGS. 15, 16, and 17). Substrate specificity can be determined for kinases within the same family (for example, FIGS. 18, 19, and 20). Peptides identified can be further tested as substrates for the kinase or inhibitors of the kinase. Kinase inhibitors, such as candidate inhibitors, can also be screened using the peptide arrays of the present invention, for example as shown in used to determine the effect on kinase activity of different inhibitors (see for example, FIGS. 21, 22, and 23).

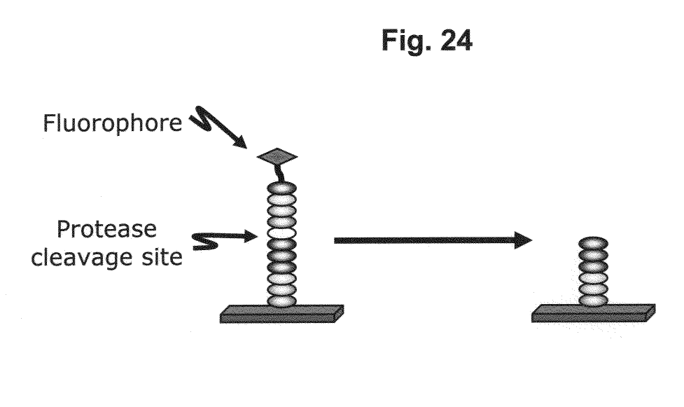

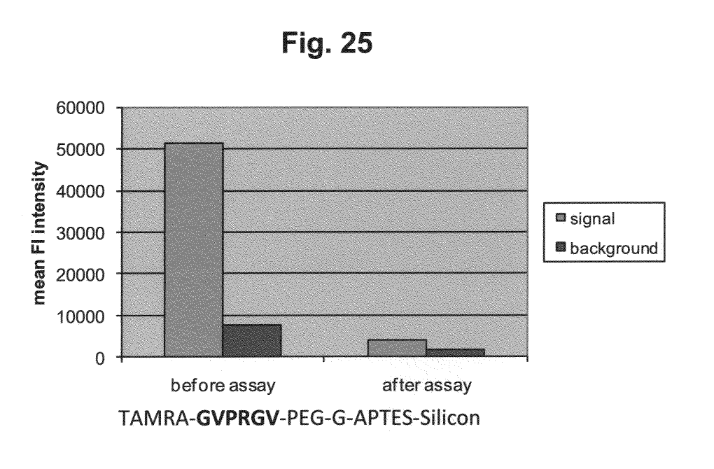

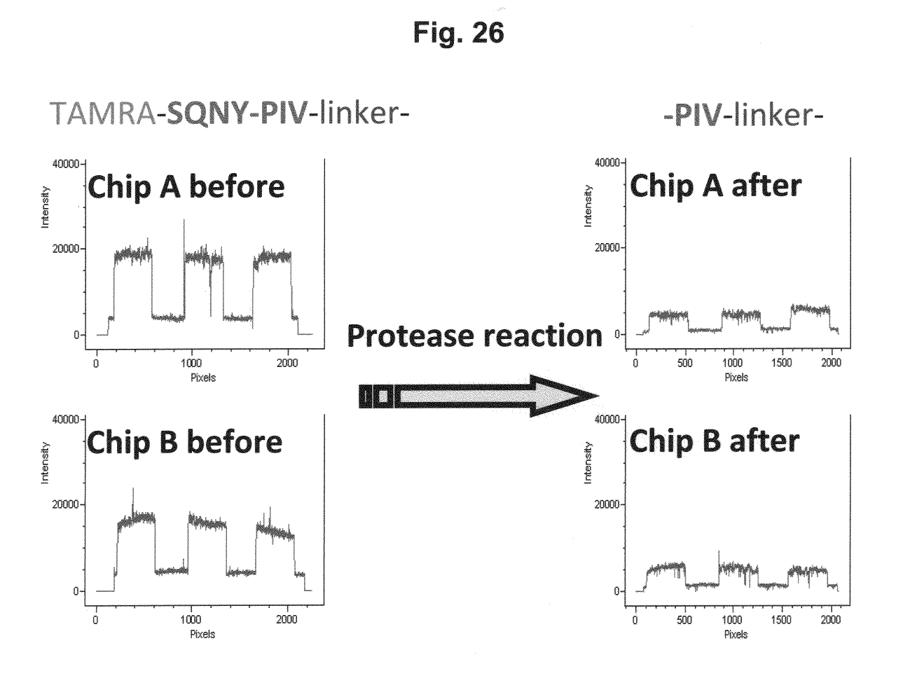

In certain embodiments, hydrolases such as proteases, phosphatases, lipases, and esterases are screened using peptide arrays of the present invention. Cleaved peptides can be measured by having fragments detected by mass spectrometry or by optical means such as fluorescence, wherein the peptides on the array were labeled. For example, a protease can have its activity measured by peptide cleavage, as shown in FIG. 24, wherein the peptide is labeled with a fluorophore and cleavage measured by the amount of fluorescence. Many tags are available for labeling peptides, for example, including, but not limited to, fluorescein, eosin, Alexa Fluor, Oregon Green, Rhodamine Green, tetramethylrhodamine, Rhodamine Red, Texas Red, coumarin and NBD fluorophores, QSY (Invitrogen), dabcyl and dabsyl chromophores and biotin. For example, as shown in FIGS. 25 and 26, the fluorescence intensity of the peptide array before and after cleavage assays with trypsin (FIG. 26) and HIV-1 protease (FIG. 26). Another assay for proteases or other proteins for substrate specificity is through binding assays. The test protein can be labeled and binding measured by determining the amount of label being bound and to which peptide the test protein is binding, based on the location of the label.

Peptide arrays can also be used in simple screening assays for ligand binding, to determine substrate specificity, or to determine the identification of peptides that inhibit or activate proteins. For example, peptides that bind signaling receptors involved in cell growth. Labeling techniques, protease assays, as well as binding assays are well known by one in the arts.

In yet another embodiment, phosphatases can be screened with the peptide array. The peptide array used to screen phosphatases is one having at least a subset if not all of its peptides be phosphatases substrates. In one preferred embodiment, the subset or all of the peptides synthesized on such array are selected from a publicly available phosphobase such as http://www.cbs.dtu.dk/databses/PhosphoBase/ or fragments thereof. Assays used may include binding assays and phosphatase assays, both techniques being well known to one in the arts.

In another embodiment, antibodies are screened on the peptide array, wherein the peptides of the array are epitopes. Epitopes for specific antibodies are determined and can also be used to generate antibodies or to develop vaccines.

In another example, the peptide array can be used to identify biomarkers. Biomarkers may be used for the diagnosis, prognosis, treatment, and management of diseases, including, but not limited to diseases such as a disease associated with apoptosis, a disease associated with signal transduction pathways of GPCRs, cancer, autoimmune diseases, and infectious diseases. Biomarkers may be expressed, or absent, or at a different level in an individual, depending on the disease condition, stage of the disease, and response to disease treatment. Biomarkers may be DNA, RNA, proteins (e.g., enzymes such as kinases), sugars, salts, fats, lipids, or ions.

For example, an individual had a cancer biomarker which is an antigen. The individual has a specific cancer, stage of cancer, or response to certain cancer treatments. The individual's autoantibodies are obtained through their serum and screened against variety of peptides on a peptide array. The identification of specific peptides that bind to autoantibodies also leads to the discovery of new biomarkers and provides insight to the mechanism of the disease that causes generation of the autoantibodies. In another embodiment, the binding of the autoantibodies to specific peptides can create an “autoantibody signature”. The autoantibody signature is specific to a particular disease, stage of the disease, or response to certain disease treatments. Thus, the autoantibody signature can be useful in determining the diagnosis for other individuals with a similar signature, or for example, including an individual in a clinical trial.

The applications for research using peptide arrays is numerous and information about enzyme/substrate, enzyme/inhibitor, antibody/antigen, and protein/protein interactions can illuminate understanding of biological processes leading to the drug discovery and development.

A peptide array can be used for epidemiology research. For example, a peptide array can be used to determine the causative agent of a disease. A sample from a patient with a disease can be applied to a peptide array as described above, such as a peptide array containing peptides with sequences from viruses, bacteria, or microorganisms. Binding to the peptide array by antibodies produced by the patient to the infectious agent can be used to determine identify the agent that caused the disease.

The peptide array of the present invention can be used to study antigen specific tolerance therapy and other immunoregulatory therapies.

### Use of Peptide Arrays for Therapeutic Purposes

The methods of the present invention also provides for methods of identifying bioactive agents. A method for identifying a bioactive agent can comprise applying a plurality of test compounds to an ultra high density peptide array and identifying at least one test compound as a bioactive agent. The test compounds can be small molecules, aptamers, oligonucleotides, chemicals, natural extracts, peptides, proteins, fragment of antibodies, antibody like molecules or antibodies. The bioactive agent can be a therapeutic agent or modifier of therapeutic targets. Therapeutic targets can include phosphatases, proteases, ligases, signal transduction molecules, transcription factors, protein transporters, protein sorters, cell surface receptors, secreted factors, and cytoskeleton proteins. For example, a therapeutic target can be a kinase or GPCR. In other embodiments, the therapeutic target is a molecule involved in DNA damage or apoptosis, such as those in FIG. 6 or 7. Therapeutic targets can include any molecule involved in a condition or disease, for example, molecules involved in inflammation, neurodegenerative diseases, or Alzheimer's disease, such as shown in FIG. 8 or 9.

In another aspect of the present invention, the peptide arrays are used to identify drug candidates for therapeutic use. In one embodiment, peptides identified by using peptide arrays in screening assays such as those mentioned above for ligand binding to determine substrate specificity can further be used to determine the peptide activity for a given test substrate. For example, whether the peptide inhibits or activates the activity of the test substrate. Peptides can screened as a potential drug by determining if the peptides can inhibit an aberrant active protein causing disease in an individual. An example is whether a peptide identified as binding a kinase may inhibit kinase activity of the given kinase. The peptide may then be used as a therapeutic agent, as kinases are implicated in a number of conditions and disorders, such as cancer. In another embodiment, wherein epitopes for specific antibodies are determined by an assay mentioned above, the epitopes may be developed as a drug to target antibodies in disease. Another embodiment is the identification of ligands for receptors through the use of peptide arrays, in which the peptides can then be used as a therapeutic against diseases in which there is excessive receptor signaling causing diseases such as cancer.

### Use of Peptide Arrays for Medical Diagnostics

In one aspect, the present invention provides peptides arrays for the use of medical diagnostics. The peptide array may be used in determining response to administration of drugs or vaccines. For example, an individual's response to a vaccine can be determined by detecting the antibody level of the individual by using an array with peptides representing epitopes recognized by the antibodies produced by the induced immune response. Another diagnostic use is to test an individual for the presence of biomarkers, samples are taken from a subject and the sample tested for the presence of one or more biomarkers. For example, a subject's serum can be used as a sample and the presence of a cancer antigen, such as prostate-specific antigen (PSA) is used to diagnose prostate cancer. However, in general, the current methods of using a single biomarker for diagnosis of a condition is severely limited as many biomarkers currently in use, such as PSA and carcinoembryonic antigen (CEA), have limited sensitivity and specificity (Cho-Chung, Biochimica et Biophysica Acta 1762 (2006) 587-591).

Multiple studies have shown that patient with cancer produce detectable autoantibodies to certain tumor-associated antigens. Autoantibodies are produced by individuals in an immune response to cancer. Autoantibodies themselves can thus be used as biomarkers, and detected by peptides specific to the autoantibodies. The peptide array allows for better sensitivity and specificity in testing of biomarkers and also allows for easy testing of a number of biomarkers with one sample.

Biomarkers other than PSA and CEA, such as extracellular cAMP-dependent protein kinase A (ECPKA), a normally intracellular protein that is secreted in serum of cancer patients, can also be used. Biomarkers that have been used that are not as specific or sensitive but now may be useful in diagnosis with the use of peptide arrays include serum oetopontin (previously implicated in lung cancer), p53 (used in the diagnosis of pancreatic cancer), CEA (for the diagnosis of colon, lung, breast, ovarian, bladder cancers), as well as tumor associated glycoprotein-72 (TAG-72), carbohydrate antigen (CA19-9), lipid associated sialic acid (LASA), alpha-fetoprotein (AFP, for the diagnosis of liver cancer), CA125 (for the diagnosis of ovarian), CA15-3 (for the diagnosis of breast cancer), human chorionic gonadotropin (hCG, for the diagnosis of breast cancer), prostatic acid phosphatase (PAP, for the diagnosis of a prostate cancer marker). (Cho-Chung, Biochimica et Biophysica Acta 1762 (2006) 587-591; Nesterova et al., Biochimica et Biophysica Acta 1762 (2006) 398-403). Other autoantibodies that may be detected by the present invention include those in Table 1.

The biomarkers associated with the above cancers are not limited to their use in the detection of that specific cancer. For example, a plurality of autoantibodies can be recognized by a peptide array, forming an autoantibody signature specific for prostate cancer. The autoantibodies in the signature for prostate cancer diagnosis may include autoantibodies that had previously been associated with biomarkers to diagnose cancers not of the prostate. Autoantibodies to 22 peptides have been identified in determining presence of prostate cancer and are better at diagnosing prostate cancer in comparison to the conventional biomarker of PSA (Wang et al. N. Engl. J. Med. (2005) 1224-1235). Peptides based on the 22 sequences in Table 2, or a subset thereof, and are specifically recognized by the autoantibodies that detect the sequences in Table 2, are synthesized on an array. An individual's serum can then be used to screen against the peptide array to determine a prostate cancer diagnosis, prognosis, treatment, and management for the individual. Prognosis may depend on the autoantibody signature and thus information on the stage of the cancer may be determined, such as whether it affects part of the prostrate, the whole prostate, or has spread to other places in the body. Treatment and management of the cancer will vary depending on the prognosis, examples being surgery, chemotherapy, hormone therapy, cryosurgery, biologic therapy, radiation therapy, or high intensity ultrasound therapy.

Autoantibodies produced by individuals in response to other diseases, such as autoimmune diseases, inflammatory diseases, cardiovascular diseases, metabolic diseases, and infectious diseases, can be also detected by the peptide arrays of the present invention. For example, peptides (e.g. epitopes) specific to the autoantibodies of autoimmune diseases such as systemic lupus erythematosis (SLE), scleroderma, rheumatoid arthritis (RA), or Sjogren syndrome, are produced on an array. The resulting peptide array is then used in the detection of an individual's autoantibodies, and thus, the diagnosis, prognosis, treatment, and management of an individual's disease can be determined based on the determination of an individual's autoantibodies. Similarly, peptides specific to autoantibodies produced in infectious diseases are used to determine the presence of an infectious agent in an individual, stage of infection, etc.

A condition that can be diagnosed or prognosed with a peptide array includes, for example, cancer, autoimmune disorder, an infectious disease, an epidemic, transplant rejection, a metabolic disease, a cardiovascular disease, a dermatological disease, a hematological disease, a neurodegenerative disease, an inflammatory disease, and infarctions (e.g. myocardial infarction, stroke).

The peptide array of the present invention can be used to diagnose or prognose cancers including, for example, prostate cancer, lung cancer, colon cancer, bladder cancer, brain cancer, breast cancer, esophageal cancer, Hodgkin lymphoma, kidney cancer, larynx cancer, leukemia, liver cancer, melanoma of the skin, myeloma, non-hodgkin lymphoma, oral cavity cancer, ovarian cancer, pancreatic cancer, rectal cancer, stomach cancer, testicular cancer, thyroid cancer, urinary bladder cancer, and cervical cancer.

A peptide array of the present invention can be used to diagnose or prognose cancers including epidemics caused by, for example, viruses, bacteria, or parasites, or non-infectious agents.

A peptide array of the present invention can be used to diagnose or prognose metabolic disease including, for example, abetalipoproteinemia, adrenoleukodystrophy (ALD), crigler-najjar syndrome, cystinuria, hartnup disease, histidinemia, Menkes disease, phenylketonuria (PKU), sitosterolemia, Smith-Lemli-Opiz syndrome, tyrosinemia type I, urea cycle disorders, Wilson's disease, Zellweger syndrome, maple syrup urine disease (MSUD; branched-chain ketoaciduria), glycogen storage disease, glutaric acidemia type 1, alcaptonuria, medium chain acyl dehydrogenase deficiency (glutaric acidemia type 2), acute intermittent porphyria, Lesch-Nhyhan syndrome, congenital adrenal hyperplasia, Kearns-Sayre syndrome, Gaucher's disease, diabetes (type 1), hereditary hemochromatosis, and Niemann-Pick disease.

A peptide array of the present invention can be used to diagnose or prognose cardiovascular disease including, for example, angina, arrhythmia, atherosclerosis, cardiomyopathy, cerebrovascular accident (stroke), cerebrovascular disease, congenital heart disease, Jye Berghofer Syndrome, congestive heart failure, myocarditis, valve disease, coronary artery disease, dilated cardiomyopathy, diastolic dysfunction, endocarditis, high blood pressure (hypertension), hypertrophic cardiomyopathy, mitral valve prolapse, myocardial infarction, venous thromboembolism.

A peptide array of the present invention can be used to diagnose or prognose dermatological disorders including, for example, acne, actinic keratosis, angioma, Athlete's foot, aquagenic pruritus, argyria, atopic dermatitis, baldness, basal cell carcinoma, bed sore, Behcet's disease, blepharitis, boil, Bowen's disease, bullous pemphigoid, canker sore, carbuncles, cellulitis, chloracne, chronic dermatitis of the hands and feet, cold sores, contact dermatitis (includes poison ivy, oak, sumac), creeping eruption, dandruff, dermatitis, dermatitis herpetiformis, dermatofibroma, diaper rash, dyshidrosis, eczema, epidermolysis bullosa, erysipelas, erythroderma, friction blister, genital wart, gestational pemphigoid, Grover's disease, hemangioma, Hidradenitis suppurativa, hives, hyperhidrosis, ichthyosis, impetigo, jock itch, Kaposi's sarcoma, keloid, keratoacanthoma, keratosis pilaris, Lewandowsky-Lutz dysplasia, lice infection, Lichen planus, Lichen simplex chronicus, lipoma, lymphadenitis, malignant melanoma, melasma, miliaria, molluscum contagiosum, nummular dermatitis, Paget's disease of the nipple, pediculosis, pemphigus, perioral dermatitis, photoallergy, photosensitivity, Pityriasis rosea, Pityriasis rubra pilaris, porphyria, psoriasis, Raynaud's disease, ringworm, rosacea, scabies, scleroderma, scrofula, sebaceous cyst, seborrheic keratosis, seborrhoeic dermatitis, shingles, skin cancer, skin tags, spider veins, squamous cell carcinoma, stasis dermatitis, sunburn, tick bite, tinea barbae, tinea capitis, tinea corporis, tinea cruris, tinea pedis, tinea unguium, tinea versicolor, tinea, tungiasis, urticaria (Hives), Vagabond's disease, vitiligo, warts, wheal (“weal” and “welt”).

A peptide array of the present invention can be used to diagnose or prognose hematological disorders including, for example Anaphylactoid Purpura (Henock-Schönlein Disease), allergic purpura (Henock-Schönlein Disease), low red blood cells (anemia), hemolytic anemia, hypoproliferative anemia, macrocytic anemia, microcytic anemia, normocytic anemia, pernicious anemia (Vitamin B12 deficiency), basophilia, blood vessel abnormalities, dysfibrinogenemia, eosinophilia, erythrocytosis/polycythemia, essential thrombocythemia, excess platelets (thrombocytosis), excess red blood cells (erythrocytosis/polycythemia), excess white blood cells (leukocytosis), Factor V Leiden Mutation, fibrin clot formation abnormalities, folic acid deficiency, hemophilia, hereditary von Willebrand's Disease, inherited hypercoagulation disorders, inherited platelet abnormalities, iron deficiency, low platelets (thrombocytopenia), low white blood cells (neutropenia), lymphocytosis, myelofibrosis with myeloid metaplasia, monocytosis, myeloproliferative disorders, neutrophilia, platelet abnormalities, polycythemia vera, premalignant blood disorders, scurvy, Systemic Lupus Erythematosus (SLE), thrombocytopenia, and sickle cell disease.

A peptide array of the present invention can be used to diagnose or prognose neurodegenerative diseases including, for example, alcoholism, Alexander's disease, Alper's disease, Alzheimer's disease, Amyotrophic lateral sclerosis, ataxia telangiectasia, Batten disease (also known as Spielmeyer-Vogt-Sjogren-Batten disease), bovine spongiform encephalopathy (BSE), Canavan disease, Cockayne syndrome, Corticobasal degeneration, Creutzfeldt-Jakob disease, Huntington's disease, HIV-associated dementia, Kennedy's disease, Krabbe's disease, Lewy body dementia, Machado-Joseph disease (Spinocerebellar ataxia type 3), multiple sclerosis, Multiple System Atrophy, narcolepsy, neuroborreliosis, Parkinson's disease, Pelizaeus-Merzbacher Disease, Pick's disease, primary lateral sclerosis, prion diseases, Refsum's disease, Sandhoff's disease, Schilder's disease, subacute combined degeneration of spinal cord secondary to pernicious anaemia, schizophrenia, spinocerebellar ataxia (multiple types with varying characteristics), spinal muscular atrophy, Steele-Richardson-Olszewski disease, and Tabes dorsalis.

A peptide array of the present invention can be used to diagnose or prognose inflammatory diseases including, for example, asthma, autoimmune diseases, chronic inflammation, chronic prostatitis, glomerulonephritis, hypersensitivities, inflammatory bowel diseases, pelvic inflammatory disease, reperfusion injury, rheumatoid arthritis, transplant rejection, and vasculitis.

A peptide array of the present invention can also be used to diagnose or prognose a disease associated with apoptosis, a disease associated with signal transduction pathways of GPCRs.

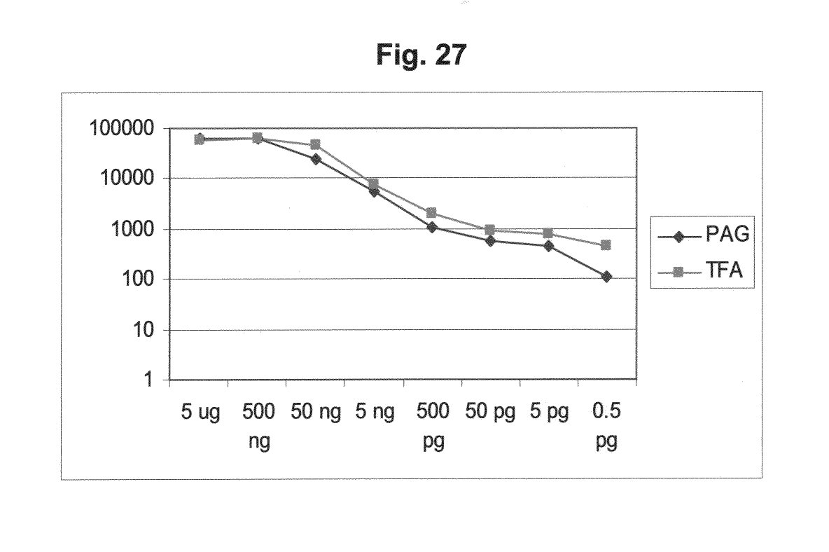

FIG. 27 illustrates an antibody binding experiment comparing binding of peptides synthesized using photo acid generation or TFA to a p53 primary antibody and fluorescein conjugated secondary antibody.

### Study of Transplant Rejection

FIG. 10 illustrates overlapping peptides that can be on an array for investigating organ transplant rejection. An antibody epitope array can be used to study organ transplant rejection. Up to 20 million organ specific 9mer peptides can be synthesized on an array, and samples from subjects can be applied to the arrays to monitor organ specific global antibody responses for diagnosis of rejection. An organ proteome can be 10,000 proteins, with each protein averaging approximately 350 amino acids. Thus, approximately 350 9mer peptides with one amino acid overlap for each protein would total approximately 3.5×10⁶ peptides for one organ specific chip. Up to 20 million overlapping 9 monomer peptides covering the full length of all known organ specific proteins can be synthesized on an array. Examples of organs whose proteomes could be used to design peptide arrays include the kidney, heart, liver. Other embodiments of the array can contain all antigenic (antigenic peptides-B cell epitopes) 9mer peptides covering the full-length of all known organ specific proteins. Another embodiment of the array contains all antigenic (antigenic peptides-B cell epitopes) peptides covering the full length of all proteins in the organ proteome. Proteins known to elicit antibodies that are markers of transplant rejection include intermediate filament vimentin, ribosomal protein L7, □-transducin, 1-TRAF or lysyl-tRNA synthetase (see U.S. Pat. No. 7,132,245). The presence of human IgM antibodies that specific to a peptide or peptides on an organ specific peptide array can indicate acute transplant rejection, and the presence of human IgG antibodies specific to a peptide or peptides on an organ specific peptide array can indicate chronic rejection.

### Enzymatic Activity Profiling

The present invention further provides determining the enzymatic activity of an enzyme using a peptide array described above. An enzyme can be applied to the peptide arrays described herein, and the enzymatic activity determined by detecting at least one change in at least one peptide from the peptide array. For example, the activity of a kinase, protease, phosphatase or other hydrolase can be determined. The activity of a single enzyme, class of enzyme, or the entire enzyme family of an organ or organism can be determined and an enzymatic activity profile generated.

The peptides arrays can be used for generating profiles for an organism. An enzymatic activity profile of an organism can be determined by applying a biological sample from the organism to peptide array, measuring the enzymatic level of the sample, and determining the enzymatic activity profile for the organism. The organism can be prokaryotic, for example such as bacteria. The organism can be eukaryotic such as yeast. Other eukaryotes can include humans and non-humans, such as animal models including mice, rats, birds, cats, dogs, sheep, goats, and cows. Biological samples can cell lysates or tissue samples. Samples can be obtained from the organism by a number of methods known in the arts.

Enzymatic profiles can be generate for a single type of enzyme, a number of enzymes, or an entire class of enzymes, or all enzymes from a biological sample. Enzymatic profiles can be generated for any enzyme, such as hydrolases or kinases. For example, an enzymatic profile can be for a single kinase, such as protein kinase C. In other embodiments, an enzymatic profile can be generated for a family of kinases, such as all cyclin-dependent kinases. In yet another embodiment, an enzymatic profile can be generated for a kinome, generating a kinome activity profile. A kinome activity profile can be generated by applying a biological sample from an organism to an ultra high density peptide array and measuring the level of phosphorylation of the peptide array.

The enzymatic profiles can be used for a multitude of purposes, such as diagnosing any of the diseases mentioned herein. For example, a biological sample from a subject can be applied to a peptide array, wherein the peptide array comprises a plurality of peptides coupled to a support, and a set of said peptides are hydrolase or kinase substrates, detecting the enzymatic activity of said sample on said peptide array; and, diagnosing a disease state in the subject.

The enzymatic profiles can also be used for determining the toxicity or efficacy profile of a subject. For example, a kinome activity profile can be used to determine the toxicity or efficacy profile of a subject. For example, a toxicity profile or an efficacy profile of a drug may be generated for a subject prior to administration of a drug or being on a particular regimen. A toxicity or efficacy profile of one or more drugs can be determined for a subject by applying a biological sample from a subject to an ultra high density peptide array. The toxicity or efficacy profile can be compared to control profiles, such as profiles from controls subjects that have responded well to the drug, or control subjects who have responded negatively to the drug, to determine how the subject may respond to the drug. The toxicity or efficacy profiles can be used to determine whether alternative drug treatments may provide better efficacy and fewer side effects or toxic effects at higher dosages. Toxicity or efficacy profiles can also be generated after a subject has been administered the drug. The profiles can be used in pre-clinical studies, for example with animal models, or be used in clinical studies, for example with humans.

The profiles can also be used to monitor the efficacy or toxicity of a drug in a subject. A first biological sample from a subject prior to administration of a drug can be applied to a first ultra high density peptide array, and a second biological sample from the subject after administration of a drug to a second ultra high density peptide array is applied. The first and said second peptide arrays can be used to generate enzymatic activity profiles and compared to monitor the toxicity or efficacy of said drug. Various treatment regimens, such as varying dosage, number of dosages, time between dosages, and different administration routes can be tested and profiles generated based on the various treatment regimens to determine the toxicity or efficacy of a drug.

The enzymatic activity profiles, such as the kinome activity profile, can also be used to stratifying a subject within a patient group. A biological sample from a subject can be applied to peptide array, the enzymatic activity profile for the subject is compared to enzymatic profiles of different subject groups, and based on the comparison, the subject is stratified into a treatment group. The enzymatic activity profiles can also be used for diagnosing or prognosing a subject, for example with a condition or disease such as cancer, inflammatory disease, neurodegenerative disease, or Alzheimer's.

Use of Peptide Arrays to Stratify Patients into Treatment Groups

Peptide arrays can also be used to stratify patient populations based upon the presence of a biomarker that indicates the likelihood a subject will respond to a therapeutic treatment. One example of patient stratification relates to the use of Herceptin® in treating breast cancer patients. Breast cancer patients respond differently to treatment with Herceptin® based on their HER-2 levels. Breast cancer patients with overexpression of HER-2 respond to treatment with Herceptin®, whereas patients that do not overexpress HER-2 do not respond to Herceptin® treatment. Thus, HER-2 is a critical biomarker for stratification of breast cancer patients into treatment groups for Herceptin®. The peptide arrays of the present invention can be used to identify known biomarkers to determine the appropriate treatment group. For instance, a sample from a subject with a condition can be applied to an array. Binding to the array may indicate the presence of a biomarker for a condition. Previous studies may indicate that the biomarker is associated with a positive outcome following a treatment, whereas absence of the biomarker is associated with a negative or neutral outcome following a treatment. Because the patient has the biomarker, a health care professional may stratify the patient into a group that receives the treatment.

In one aspect, the present invention contemplates a method for selecting therapy for a subject comprising: applying a sample from said subject to a peptide array; determining the enzymatic activity of said sample by detecting at least one change in at least one peptide from said peptide array, and selecting a therapy for said subject from determined enzymatic activity. The selecting a therapy step can comprise selecting a drug treatment, wherein the drug is a kinase inhibitor drug, a GPCR drug, an apoptosis targeting drug, neurodegenerative inhibiting drugs, or a drug targeting DNA damage repair. The subject may have a condition associated with abnormal activation of the apoptosis pathway, DNA damage repair pathway, signal transduction pathways of GPCRs, or a neurodegeneration. Examples of kinase inhibitor drugs contemplated herein include Gleevac, Dasatinib and SKI606. Examples of GPCR drugs include Zyprexa™, Clarinex™, Zantac™, and Zelnorm™. Examples of neurodegenerative inhibiting drugs include (−)-epigallocatechin-3-gallate, penserine, R-BPAP, flurbiprofen, or an AChE inhibitors. Examples of apoptosis targeting drugs are bortezomib, CCI-779, and RAD 001. An example of a DNA repair pathway drug is Trifluoperazine. In some instances, selecting a therapy step further comprises determining a treatment regimen for said subject. In some instances, selecting a therapy step comprises determining a dosage level. A peptide array used for therapy selection can be any of the ones described herein, including those having at least 5,000 different peptides.

### Use of Peptide Arrays for Biodefense

A peptide array of the present invention can also be used for biodefense. Biodefense can involve generating vaccines against diseases that can be caused by bioterrorism agents, developing diagnostic tests to rapidly identify exposures to bioterrorism agents and allow for the determination of appropriate treatments, and providing therapies to patients that have been subjected to a bioterrorism attack.

### Business Methods Relating to Peptide Arrays

The present invention contemplates business methods that produce and manufacture peptide arrays having the features described herein. For example, in some cases a peptide array is one produced using photolithography using photoresist and RAC or other means described herein. In some embodiments, the peptide array is produced or manufactured without a mask. In some embodiments, the peptide array is produced using an electrochemical reagent and methods.

The methods of the present invention includes manufacturing a peptide array comprising applying photoresist to a plurality of monomers on a support; removing the photoresist in selected regions using photolithography, for example, with the use of a mask or micromirrors; causing acid or base labile protecting groups to be removed form the monomers indirectly; delivering monomers to the array to generate a plurality of peptides whose sequences have a hydrolase site or phosphorylation site at a different position than the other sequences in the peptide cluster. In some embodiments, the peptide sequences overlap to form a common protein sequence with at least one enzymatic reaction site, such as a protease, phosphatase, or phosphorylation site. The peptides can be substrates for at least 50% of the proteases of an organ or an organism, at least 50% of the phosphatases of an organ or an organism, at least 50% of the kinases of an organ or an organism, or the entire kinome of an organ or organism. The peptides can be substrates for a pathway, such as proteins downstream of a G-protein coupled receptor.

Such peptide array can have any of the features described herein. For example, each region or feature can be between 0.2 to 100 um², 0.2 to 10 um², 0.2 to 1 um², 0.2 to 0.5 um², or up to 0.5, 1, 5, 10, 15, 20, 25, 50, 100, 250, 500, 1000 um². The array can at least 20, 100, 200, 300, 400, 800, 1000, 1500, 2000, 3000, 4000, 5000, 10,000, 20,000, 50,000, 75,000, 100,000, 150,000, 200,000, 300,000, 400,000, 500,000, 1,000,000, 2,000,000, 2,250,000, 5,000,000, 10,000,000, or 100,000,000 unique peptides on a single array. The peptide arrays can also have substrate peptide clusters.

The business method above can provide the above arrays for consumers for research and diagnostic purposes. A business method herein provides a service in exchange for a fee to customers whereby a sample is sent to the business for research or diagnostic purposes, and the business analyzes the sample using one or more of the peptide arrays described herein and sends a report to the customer with analysis of the sample. The business than provides information about the sample to the customer. The information can be a diagnostic, e.g., whether a patient has a condition such as cancer, Alzheimer's, an autoimmune disorder, etc. The information can be provided to a customer to stratify or select patients for a clinical study, e.g., whether the patient is susceptible to drug toxicity. The information can also provide a general health monitoring tool to a doctor by providing an enzyme profile or kinase profile (finger print) or research information.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

### Characteristics of the Features of the Peptide Arrays

An array of the present invention can comprise hundreds, thousands, or millions of features. A feature is a localized area on a support which is, was, or is intended to be used for formation of a selected polymer or polymers. A feature may have any convenient shape, e.g., circular, elliptical, wedge-shaped, linear, or rectangular, such as a square. Feature sizes can be up to approximately 0.5, 1, 2.5, 5, 10, 15, 20, 25, 50, 100, 250, 500, 1000, or 10,000 um2 or between 0.2 to 100 um², 0.2 to 10 um², 0.2 to 1 um², or 0.2 to 0.5 um². Smaller features allow for increased numbers of features per given support size. For example, a peptide array manufactured by the methods herein can have at least 20, 100, 200, 300, 400, 800, 1000, 1500, 2000, 3000, 4000, 5000, 10,000, 20,000, 50,000, 75,000, 100,000, 150,000, 200,000, 300,000, 400,000, 500,000, 1,000,000, 2,000,000, 2,250,000, 5,000,000, 10,000,000, or 100,000,000 features on a single support. For example, the numbers of features on a 6×6 mm² array can be at least 14,400, 57,600, 90,000, 160,000, or 360,000. The number of features on a 1.5×1.5 cm² array can be at least 225, 900, 3,600, 22,500, 90,000, 360,000, 562,500, 1,000,000, 2,250,000, 10,000,000, or 100,000,000.

The number of copies of a peptide within a feature can be from at least 1 to at least 10. In some embodiments, at least 100 peptides are located within a feature. In some embodiments, the number of peptides in a feature can be in the thousands to the millions. Within features, the peptides synthesized therein are preferably synthesized in a substantially pure form. In some instances, only up to 50%, 60%, 70%, or 80% of peptides within a feature are identical to a predetermined sequence.

At least a subset of features comprises peptides with sequences as in another feature on the same array. In the alternative, at least a subset of features in an array can comprise peptides whose sequences are different than the peptide sequences of the other features. A single peptide array can also have features that have the same peptide sequence as other features, as well as features with a different peptide sequence than other features. In some embodiments, each of the features on a peptide array can comprise a different sequence. For example, a peptide array manufactured by the methods herein can have at least 20, 100, 200, 300, 400, 800, 1000, 1500, 2000, 3000, 4000, 5000, 10,000, 20,000, 50,000, 75,000, 100,000, 150,000, 200,000, 300,000, 400,000, 500,000, 1,000,000, 2,000,000, 2,250,000, 5,000,000, 10,000,000, or 100,000,000 different peptide sequences on a single array. The feature density on an array can be greater than 100,000, 500,000, 1,000,000, 50,000,000, or 100,000,000/cm². The array can have dimensions of such as those of any known nucleic acid array, including 6×6 mm² or 1.5×1.5 cm².

In some instances at least 1%, 5%, 10%, 25%, 50%, 75%, 85%, 90%, or 99% of the peptides on the array may have a different sequence, i.e., sequence different from all other sequences on that same array. For example, a peptide array made using photolithography can have peptides with more than 100,000, 150,000, 200,000, 500,000, 1,000,000, 2,000,000, 10,000,000, 20,000,000, or 100,000,000 different sequences.

At least a subset of peptide(s) on an array can have a different number of monomers from the other peptides. In the alternative, at least a subset of peptides on an array can have the same number of monomers. For example, a peptide array can have at least a subset of peptides or all peptides with between 2 to 150 monomers, 3-50 monomers, or 4-10 monomers. At least a subset of peptides or all peptides can have 3, 4, 5, 6, 7, 8, 9, 10, 11, 12, 13, 14, 15, 16, 17, 18, 19, or 20 monomers.

TABLE 1
Reported tumor antigens recognized by autoantibodies in
various cancer patients' sera, identified by proteomic methods

| Antigens | Types of tumor | Sera positive (rate) | Method |
|---|---|---|---|
| Annexin I | Lung adeno | 12/30 (40%) | 2D-W* |
| | Lung squamous | 3/18 (17%) | |
| Annexin II | Lung adeno | 11/30 (37%) | 2D-W |
| | Lung squamous | 4/18 (22%) | |
| PGP9.5 | Lung adeno | 6/40 (15%) | 2D-W |
| Vimentin | Pancreas adeno | 16/36 (44%) | 2D-W |
| Calreticulin | Pancreas adeno | 21/36 (58%) | 2D-W |
| UCH-L3 | Colon | 19/43 (44%) | Protein |
| | | | microarray |
| β-tubulin I and III | Neuroblastoma | 11/23 (48%) | 2D-W |
| RS/DJ-1 | Breast | 13/30 (43%) | 2D-W |
| Calreticulin | Liver HCC | 10/37 (27%) | 2D-W |
| β-tubulin | ″ | 9/37 (24%) | 2D-W |
| HSP60 | ″ | 5/37 (14%) | 2D-W |
| Cytokeratin 18 | ″ | 5/37 (14%) | 2D-W |
| Cytokeratin 8 | ″ | 4/37 (11%) | 2D-W |
| Creatine kinase B | ″ | 5/37 (14%) | 2D-W |
| F1-ATP | ″ | | 2D-W |
| synthetase □subunit | ″ | 4/37 (11%) | 2D-W |
| NDPKA | ″ | 5/37 (14%) | 2D-W |
| Carbonic anhydrase I | Kidney RCC | 3/11 (27%) | 2D-W |
| SM22-□ | ″ | 5/11 (45%) | 2D-W |

*2-dimensional polyacrylamide gel electrophoresis, followed by Western blot.
**Adapted from Imafuku et al., Disease Markers, 20 (2004) 149-153.

TABLE 2
Sequence identify of 22 phage peptides detected
by autoantibodies for prostate cancer

| | Peptide Sequences |
|---|---|
| cDNA Identity | (*, stop codon) |
| eIF4G1 | IRDPNQGGKDITEEIMSGARTASTPTPPQTGGGLEPQ |
| | ANGETPQVAVIVRPDDRSQGAIIADRPGLPGPEHSPS |
| | ESQPSSPSPTPSPSPVLEPGSEPNLAVLSIPGDTMTT |
| | IQMSVEE* |
| BRD2 | ESRPMSYDEKRQLSLDINKLPGEKLGRVVHIIQAREP |
| | SLRDSNPEEIEIDFETLKPSTLRELERYVLSCLRKKP |
| | RKPYSTYEMRFISWF* |
| RPL13a | RCEGINISGNFYRNKLKYLAFLRKRMNTNPSRGPYHF |
| | RAPSRIFWRTVRGMLPHKTKRGQAALDRLKVFDGIPP |
| | PYDKKKADGGSCCPQGRASEAYKKVCLSGAPGSRGWL |
| | EVPGSDSHPGGEEEACGRTRVTS* |
| RPL22 | ITVTSEVPFSKRYLKYLTKKYLKKNNLRDWLRVVANS |
| | KESYELRYFQINQDEEEEESLRPHSSN* |
| hypothetical | PASASILAGVPMYRNEFTAWYRRMSVVYGIGTWSVLG |
| protein | SLLYYSRTMAKSSVDQKDGSASEVPSELSERPSLRPH |
| XP_353238 | SSN* |
| UREB1 | RMPKEPLKIPVATSRTQASLGKQKCRRRIMMSLRQRW |
| | QMGISWMGRLKPTQW* |
| PLS3 | EGSVYQCCEKGKKQVCSQRIFKWMRWLPLRFPKMSLM |
| | NSKRLPLQKLISTATDSFVTMNFMSSSRKLICHYQDI |
| | K* |
| BRMS1L | APRTRTLRARRSPRMEIAQKWMMKTVKEEEWNVWMKC |
| | PILKNSLPISKINFIKND* |
| 5′-UTR_BMI1 | QRSGRDNGDVGAGAPFRLSSTSQPRRIKPIAPPPRAP |
| | SPECGAGGGGGGRGGGGGGPGGGGVGGRGGGGGGGGR |
| | GAGGGRGAGAGGGRPEAA* |
| 5′-UTR_BMI1 | GGGRGAGGGRGAGAGGGRPEAA* |
| 5′-UTR_BMI1 | GVGGRGGGGGGGGRGAGGGRGAGAGGGRPEAA* |
| cDNA clone | ILYPETLLKLLISLRRFWAEMMEFSRYTIMSSENRDN |
| | LTSSFPN* |
| RP3-323M22 | LVSILLTKTIY* |
| cDNA clone | QSQHGGPENFKI* |
| 3′-UTR-MEP50 | NSLPLFPPQNSMGPDIFCPGPLSLDVESLNAVFIDF* |
| LAMR1 | REMVPRMRRTSRASIHHIKPTE* |
| SFRS14 | KAECFKNLIVKKQKSLCSGFKEHLNEASILAQVSVSS |
| | SKRVWKSWENLISSFMVWNPAHLIISIPNLEKTSDLS |
| | MMSKLAAAIE* |
| cDNA clone | NNVSALLGWQK* |
| cDNA clone | PFCKFRILSPRCLSDATQWPFKVLFKWDCSSNSFLGP |
| | N* |
| 3′-UTR-EEF2 | PTLFPFLQRETQMSKLILTNALRGLFGYMARSGFCPR |
| | KGKGTRG* |
| Chromosome | NSDLPFGSLVLSSLYDSNVYSESPVFLQAHE* |
| 16 clone | |
| cDNA clone | QKLCQAKEKGMCMKKLRMLWECQKLYSLGF* |

*Adapted from Wang et al., N. Engl. J. Med., (2005) 1224-1235

### EXAMPLES

### Example 1

### Antibody Binding Testing of Peptide Array

An array with 400 peptides is generated using photoresist-RAC technology wherein each peptide is approximately 9 amino acids long. The peptides are designed to mimic epitopes to antibodies or mutants of the corresponding epitopes, the mutants being unable to bind the antibodies. Binding assays, detection sensitivity, CV, and linear dynamic range are determined with the peptide arrays using standard techniques known in the art. Results are compared to ELISA and are equivalent in sensitivity and accuracy.

### Example 2

### Detection of Autoantibodies in Prostate Cancer

Peptides based on the sequences of Table 2 are synthesized on an array using photoresist-RAC technology. Serum from a control group and a group with prostate cancer are taken and screened with the peptide array. Percentage of peptides bound is determined between the control group and cancer group. Results are compared to results from peptide phage display as described in Wang et al. N. Engl. J. Med. (2005) 1224-1235 and determined to be equivalent.

### Example 3

### Peptide Array and Kinase Assay for Abl and Src Kinases

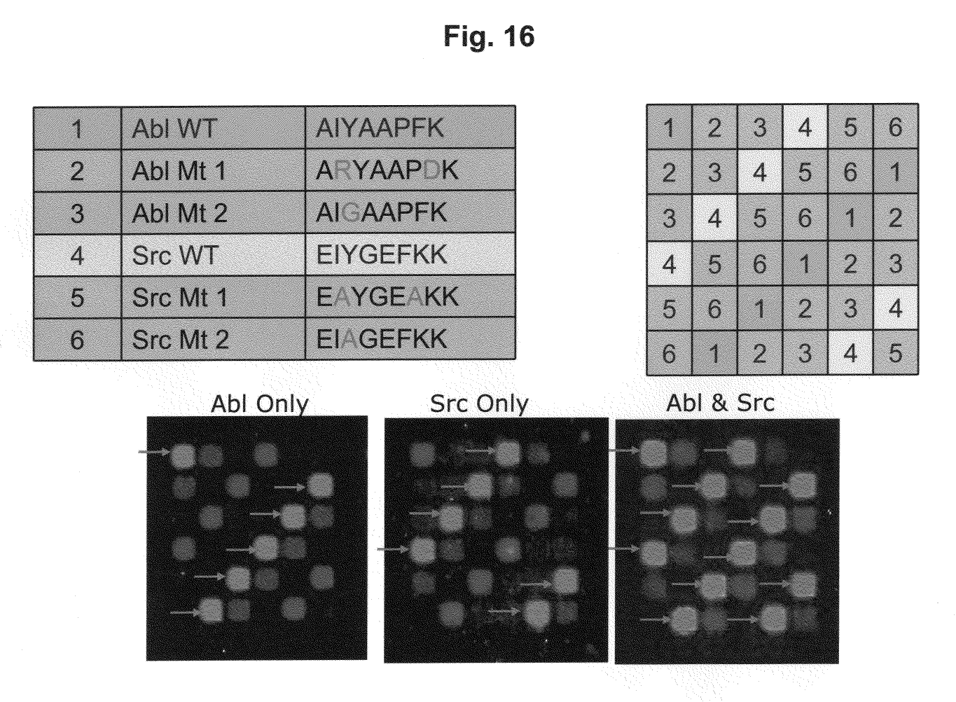

Peptide sequences as depicted in FIG. 16 were produced on a support in the pattern shown, using methods as described in Examples 1 and 2. The wild-type (WT) peptides substrates are recognized by their respective kinase. A mixture of Src and Abl kinase was applied to the peptide arrays comprising sequences 1-6. The EC50 for Src was shown to be ˜1.5 ng/μl (FIG. 15), the dynamic range approximately 0.1˜10 ng/μl, and a mixture of Src with Abl kinase did not interfere with the kinase activity of either of the individual kinases, as shown in FIG. 13B.

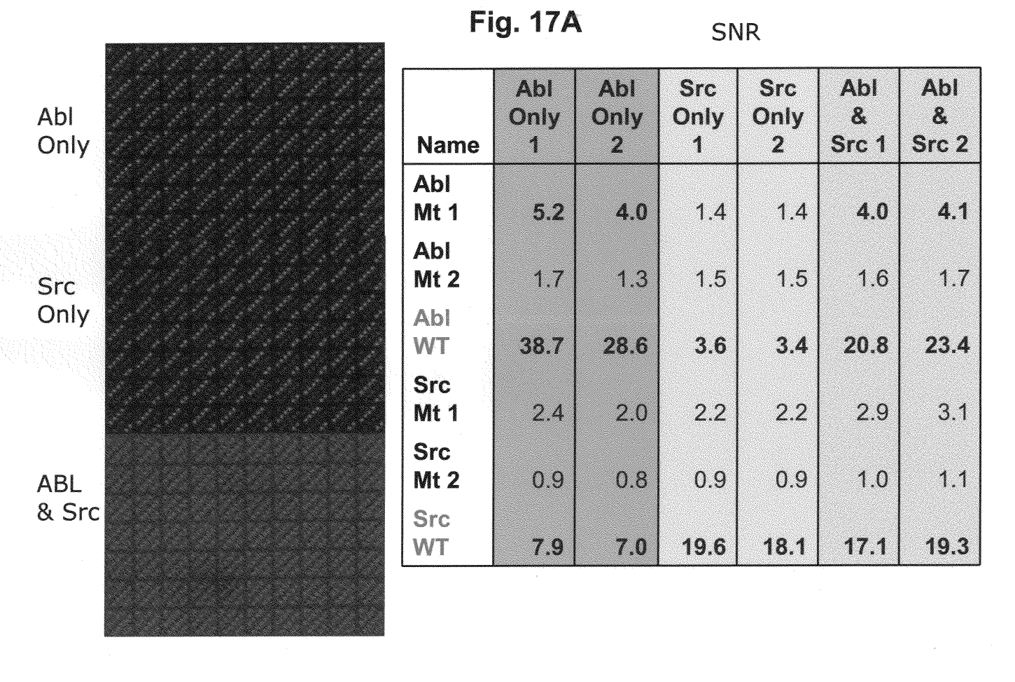

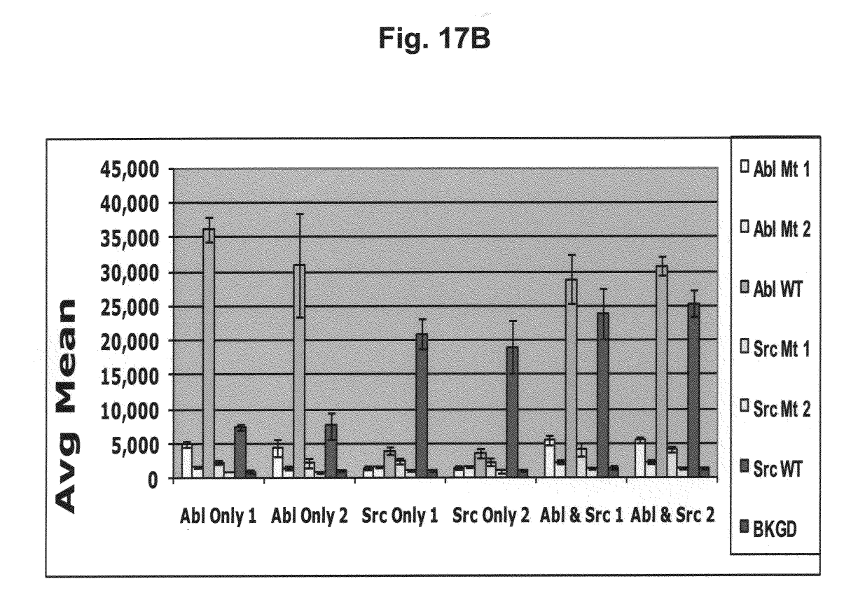

Application of the kinase mixture (see Tables 3 and 4 for reaction mixtures) demonstrated the kinase specifically phosphorylated their respective WT peptide substrate (FIG. 15). The signal to noise ratio (SNR) of the peptide arrays with Abl/Src kinase mixture was calculated (FIG. 17A).

TABLE 3
SRC Kinase Reaction Mixture

| | [stock] | [final] | DF | (ul) |
|---|---|---|---|---|
| Kinase reaction buffer | 4X | 1X | 4 | 50 |
| ATP | 10 mM | 200 uM | 50 | 4 |
| Tween20 | 5% | 0.05% | 100 | 2 |
| DTT (1:10) | 0.1 M | 1.25 mM | 100 | 2 |
| Kinase | 29.4 U/ul | 0.2 U/ul | 147 | 1.36 |
| dH2O | | | | 140.6 |

TABLE 4
Abl Kinase Reaction Mixture

| | [stock] | [final] | DF | (ul) |
|---|---|---|---|---|
| Kinase reaction buffer | 4X | 1X | 4 | 50 |
| ATP | 10 mM | 200 uM | 50 | 4 |
| Tween20 | 5% | 0.05% | 100 | 2 |
| DTT (1:10) | 0.1 M | 1.25 mM | 100 | 2 |
| Kinase | 41.2 | 0.1 U/ul | 412 | 0.49 |
| dH2O | | | | 141.5 |

### Example 4

### PKA, PKB, and PKC Kinase Specificity

PKA kinase (kinase reaction buffer as shown in Table 5, variations of the buffers in Tables 11-13 are used depending on the specific kinase) and PKB kinase belong to the same kinase family. The individual kinases were applied to peptides arrays comprising the same peptide sequences in the same configuration.

PKA and PKB have different activity against specific peptide substrates as differences in the peptide detection was determined (for example, the squared boxes highlighted in FIG. 18). The kinases show a difference in preferred specificity in position −4 (4 amino acids shifted from the phosphorylation site, Serine “S”), −1 (one position from phosphorylation site), and +1 (one position from the serine).

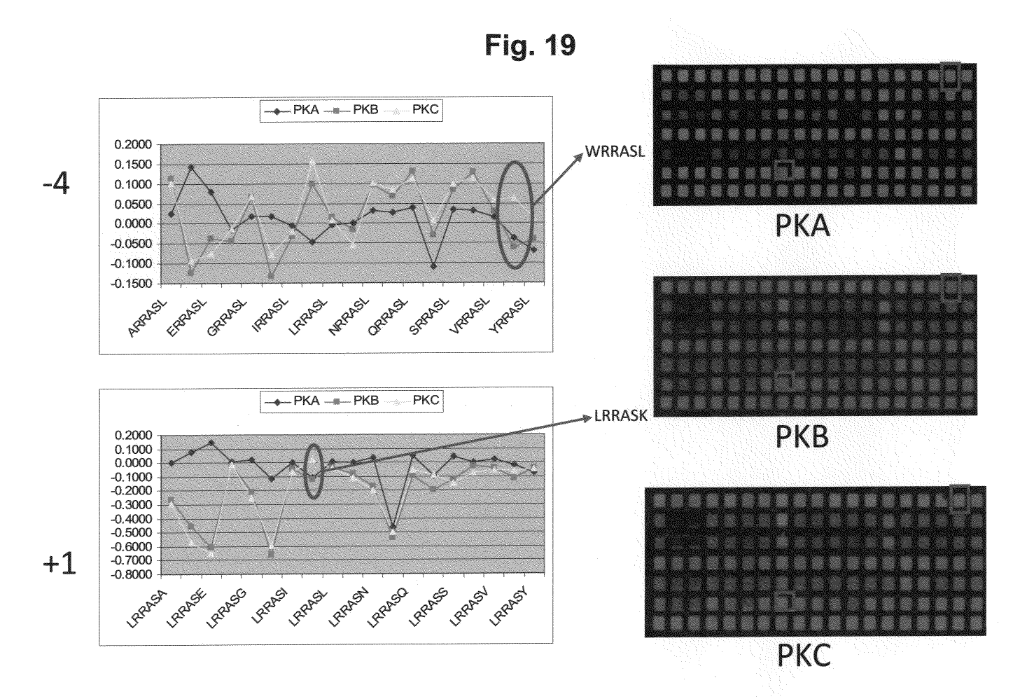

PKC was applied to another peptide array with the same peptide sequences in the same configuration as those used for PKA and PKB. PKC has a different sequence preference in comparison to PKA and PKB (FIG. 19). PKC shows a different preference in position −4 (4 amino acids shifted from the phosphorylation site, Serine “S”) and +1 (one position from the serine).

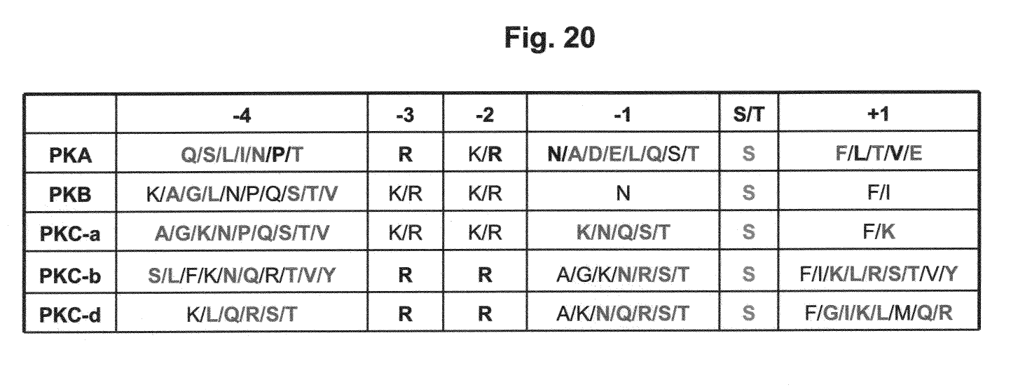

The positional preference of the AGC family kinases PKA, PKB, and PKC are shown in FIG. 20. The preference was based on relative signal intensity over kemptide (or peptide). The bolded residues are from previously published work whereas the other residues were not published.

TABLE 5
PKA Kinase Reaction Mixture

| | [stock] | [final] | DF | (ul) |
|---|---|---|---|---|
| Kinase reaction buffer | 5X | 1X | 5 | 40 |
| ATP | 10 mM | 200 uM | 50 | 4 |
| Tween20 | 5% | 0.05% | 100 | 2 |
| Kinase (1 ul aliquot) | 7.5 U/ul | | 10.0 | (1 ul + 9 ul) |
| | 75 U/ul | 1 U/ul | 75 | 2.67 |
| dH2O | | | | 151.33 |

### Example 5

### Kinase Inhibitor Assay with Staurosporin

The ATP competitive inhibitor, staurosporin (“Stau.”) was used in an Src kinase inhibitor assay. A peptide array with Src kinase substrates was produced. A kinase assay was performed using Src with Staurosporin. Staurosporin inhibited Src kinase activity by up to 80%. The IC50 was estimated to be approximately 450 nM in the presence of 2 uM ATP (FIG. 21). The IC50 of Staurosporin on Src kinase is comparable to the 200-400 nM reported in the literature.

### Example 6

### Gleevac Inhibition of Abl Kinase

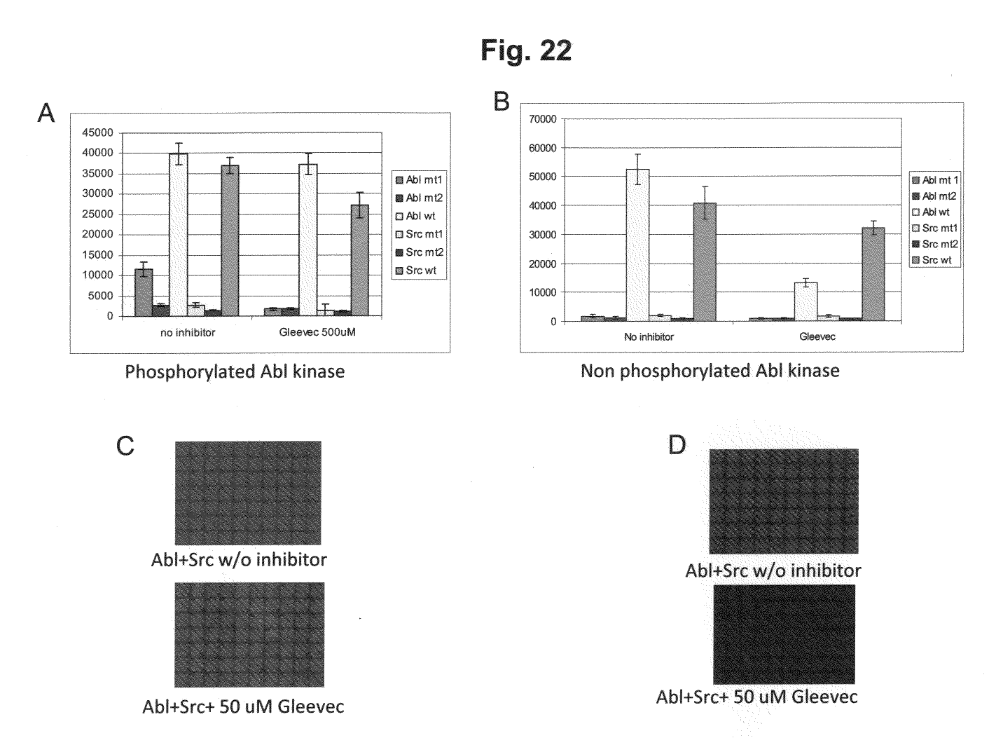

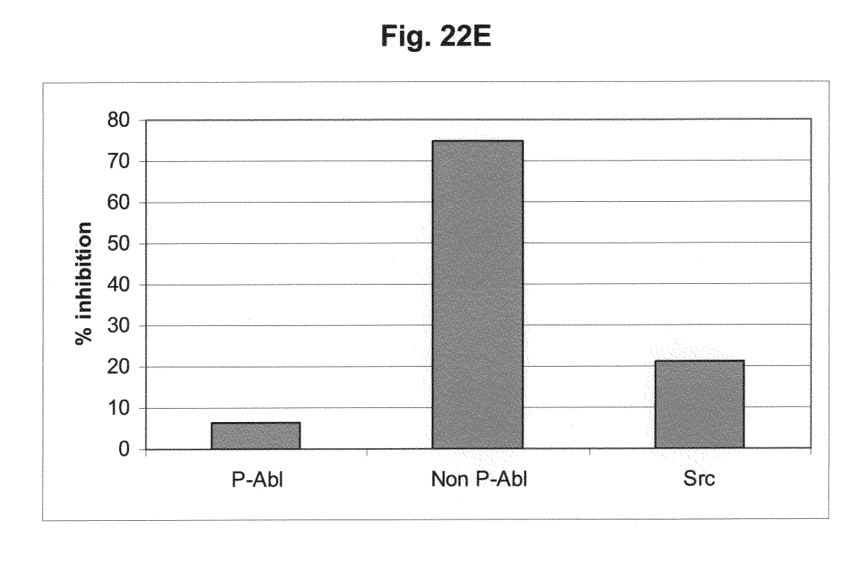

Gleevac, a commercially available kinase inhibitor, has specific bioactivity on various forms of Abl kinase. Gleevac inhibits active Abl kinase. Gleevac was used in a kinase inhibitor assay with Abl and Src kinase (FIG. 22). Gleevac inhibition of phosphorylated Abl kinase, non phosphorylated Abl kinase, and Src kinase, or both, was tested using peptide arrays with Abl and Src substrates as in Example 3. Kinase assays and peptide arrays were as described in Example 6, but with the addition of Gleevac in the kinase assay, and either phosphorylated or non-phosphoyrlated Abl kinase and Src.

Leevac does not have an effect on phosphorylated Abl kinase nor Src kinase activity (FIG. 22A). The percent inhibition of Gleevac, ˜75% Gleevac inhibition (see FIG. 22E) is consistent with other commercial assays

### Example 7

### Different Kinase Inhibitors in Kinase Inhibition Assay

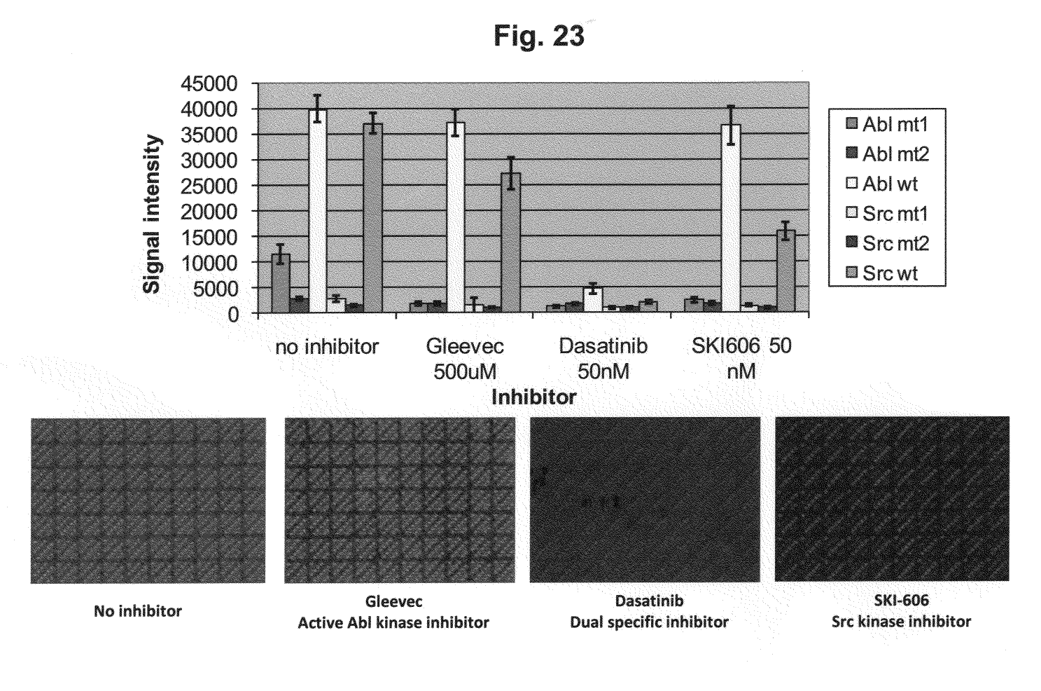

The peptide array with Abl and Src peptide substrates as described in Example 3 was used with various kinase inhibitors. Gleevac, Dasatinib and SKI606 were used in kinase assays with Abl and Src kinase. Gleevac is an active Abl kinase inhibitor, Dasatinib is a dual specific inhibitor, and SKI-606 is an Src kinase inhibitor. As shown in FIG. 23, the peptide arrays subjected to kinase assays with Src and Abl kinases and one of the three inhibitors demonstrated the expected specificity of the kinase inhibitor for their respective kinase.

### Example 8

### Kinase Substrate Array

Peptide sequences that are phosphorylated are obtained from the phosphobase http://www.cbs.dtu.dk/databases/PhosphoBase/. Mutation sequences are determined by single site scan through 20 natural amino acids. The sequences obtained from the phosphobase covers 160 kinases, 52 tyrosine kinases, and 108 serine/threonine kinases. Approximately 1184 peptide sequences are synthesized on the array using photoresist-RAC technology and each peptide comprises approximately 9 monomers. The peptides represent 629 proteins covering ˜500 human intracellular and surface kinases.

### Example 9

### Varying Phosphorylation Site Peptide Clusters

A subset of peptides on a peptide array is synthesized on a peptide array using photoresist-RAC technology. The subset of peptides is in a substrate peptide cluster. Each peptide in the peptide cluster is approximately 9 monomers long and each peptide in the cluster has a single Ser. The single Ser is in position 1 of one peptide, and shifted one monomer position in the subsequent peptides within the cluster such that each peptide in the cluster has a unique sequence (FIG. 7). Each peptide has a unique sequence but the same amino acids, for example, each peptide in the cluster can have 1 Ser, 2 Ala, 3 Gly, 1 Glu, 1 Phe, and 1 Asp, and the amino acid sequence is the same between peptides except for the Ser and the amino acid in the position it is occupying in the specific peptide. For example, peptide 1 has Ser in position 1 (P1-Ser), and P2-Ala, P3-Ala, P4-Gly, P5-Gly, P6-Gly, P7-Glu, P8-Phe, and P9-Asp. Peptide 2 has P1-Ala (P2 amino acid of peptide 1), P2-Ser, and P3 to P9 is the same as peptide 1 in the cluster. Peptide 3 will have P1-Ala (P3 amino acid of peptide 1), P3-Ser, and the remaining. P2, P4-P9 are the same amino acids in the same position as in peptide 1. The remaining peptides in the cluster, peptides 4-9 will have Ser in the P4, P5, P6, P7, P8, and P9, respectively.

### Example 10

### Constant Phosphorylation Site Peptide Clusters

A subset of peptides on a peptide array is synthesized on a peptide array using photoresist-RAC technology. The subset of peptides is in a substrate peptide cluster. Each peptide in the peptide cluster is approximately 9 monomers long and each peptide in the cluster has a single Thr. The Thr is in the same monomer position as all the other peptides in the peptide cluster (FIG. 8). The remaining monomer positions are filled with one of the remaining 17 amino acids. The number of peptides is 136 peptides to encompass all the different variations.

### Example 11

### Kinome Activity Profile

A peptide array with substrates of the human kinome is produced using photoresist technology. The peptide array has at least one substrate for each kinase in the human kinome. A tissue sample from a subject is taken and applied to the peptide array. The level of phosphorylation from the tissue sample is determined and a kinome activity profile generated for the subject. The kinome activity profile can be used for diagnosis or prognosis of a condition, such as cancer.

### Example 12

### Peptide Cleavage Assay with Trypsin

A peptide array with the peptide sequence depicted in FIG. 25, a substrate for trypsin, was produced by methods as described in Examples 1 and 2. The bolded portion is the trypsin cleavage site. The peptide was fluorescently labeled with TAMRA (5-carboxytetramethylrhodamine, available from Invitrogen) and coupled to a silicon support. The amount of fluorescence before and after treatment of the peptide array with trypsin was determined (FIG. 25). After cleavage, the amount of fluorescence decreased as expected.

### Example 13

### Peptide Cleavage Assay with HIV-1 Protease

A peptide array with the peptide sequence depicted in FIG. 26, a substrate for HIV-1 protease, was produced by methods as described in Examples 1 and 2. The bolded portion is the HIV-1 protease cleavage site. The peptide was fluorescently labeled with TAMRA (5-carboxytetramethylrhodamine, available from Invitrogen) and coupled to a silicon support. The amount of fluorescence before and after treatment of the peptide array with HIV-1 protease was determined (FIG. 26). After cleavage, the amount of fluorescence decreased as expected.

### Example 14

### (Prophetic) Diagnosis of Alzheimer's Disease

A peptide array with peptides covering the proteome of a human is used. Serum samples from subjects with Alzheimer's disease and subjects without Alzheimer's disease are applied to peptide arrays of the same configuration. A binding pattern (autoantibody signature) or a single biomarker is searched for that is characteristic of subjects with Alzheimer's disease and not subjects without Alzheimer's disease. A sample from a subject with a condition is applied to a peptide array of the same configuration. The binding pattern or the sample of the subject is compared to the binding pattern of subjects with Alzheimer's and subjects without Alzheimer's to determine if the subject has Alzheimer's disease.

### Example 15

### (Prophetic) Human Antibody Epitope Array

The human genome has approximately 30,000 genes. The average length of a protein encoded by a gene is 350 amino acids. Thus, 342 peptides of nine amino acids are needed per protein to have an eight amino acid overlap. Thus, 342×30,000=10,260,000 peptides are synthesized on a support to cover the whole human proteome. For a 3 amino acid overlap, (342/6)=1,7100,000 peptides are synthesized on a support.

### Example 16

### Peptide Synthesis on Glass or Silicon Surface

### Preparation and Silanation

A solid support, plain glass (dimension: 1×3 inches, thickness: 0.9-1.1 mm, Corning 2947) or silicon (dimension: 1×3 inches, thickness: 725 μm, SVM) slide or surface, was cleaned by dipping in piranha solution (100 ml of 30% H₂O₂ with 100 mL of H₂SO₄) for over 30 minutes with shaking. The slide was then washed with deionized water, 3 times for 5 min each (shaking each time). The slide was then washed with 95% ethanol, once for 5 min with shaking. The oven is turned on and set to 110° C. The slide are transferred into 0.5% APTES solution (1 mL of 3-aminopropyl-triethoxysilane (APTES) with 199 mL of 95% ethanol) and for 30 min with shaking. The slide was then washed with 95% ethanol, once for 5 min (with shaking), then washed with isopropanol once for 5 min shaking. The wafer was then dried with N₂ in the oven at 50° C.

The slide was then transferred and cured at 100-110° C. in N₂ atmosphere oven for 60 min. The slide was then placed into a vacuum chamber filled with N₂. This was repeated twice.

### Glycine Coupling

Next the slide was derivitized with glycine. The surface was neutralized with 5% (v/v) diisopropyl ethyl amine (DIEA)/dimethylformamide (DMF) for 5 min by dipping the slide in a DIEA bath. The slide was then washed with DMF twice for 5 min each and then with 1-methyl-2-pyrrolidone (NMP) twice for 5 min each.

The slide was then transferred to AA coupling solution (Table 6a and 6b) bath for 1 hour with shaking at room temperature.

TABLE 6a
AA Coupling Solution (glycine/DIC)

| | | MW | d | final | final | | | |
|---|---|---|---|---|---|---|---|---|
| REAGENTS | Source | (g/mol) | (g/ml) | conc (M) | vol (L) | moles | grams | mls |
| Boc-Gly-OH | EMD | 175.19 | | 0.1 | 0.2 | 0.02 | 3.5038 | |
| | bioSciences | | | | | | | |
| HOBt, anhydr | Acros | 135.13 | | 0.1 | 0.2 | 0.02 | 2.7026 | |
| DIC | Aldrich | 126.2 | 0.815 | 0.1 | 0.2 | 0.02 | 2.524 | 3.0969 |
| (diisopropylcarbodiimide) | | | | | | | | |
| NMP | Fluka | | | | 0.2 | | | |

TABLE 6b
AA Coupling Solution (glycine/HATU)

| | | MW | d | final | final | | | |
|---|---|---|---|---|---|---|---|---|
| REAGENTS | Source | (g/mol) | (g/ml) | conc (M) | vol (L) | moles | grams | mls |
| Boc-Gly-OH | Aldrich | 175.19 | | 0.1 | 0.01 | 0.001 | 0.17519 | |
| HOBt | Nova | 135.13 | | 0.1 | 0.01 | 0.001 | 0.13513 | |
| HATU | Aldrich/CPC | 380.23 | | 0.1 | 0.01 | 0.001 | 0.380 | |
| DIEA | Aldrich | 129.25 | 0.742 | 0.2 | 0.01 | 0.002 | 0.259 | 0.348 |
| NMP | Aldrich | | | | 0.01 | | | |

The solution was replaced with 2% acetic anhydride/DMF for 30 min with shaking at room temperature. The slide was then washed with DMF twice, 5 min each, with isopropanol (IPA) twice, 5 min each. The slide was then rinsed with IPA, dried with N₂ in the oven at 50° C. and then stored in a petri dish at room temperature.

### Fluorescein Staining

Boc was removed by treating the slide with trifluoroacetic acid (TFA) for 15 min, then washed with IPA 3 times, then washed with DMF for 5 min. The slide was then dipped into 5% (v/v) DIEA/DMF for 5 min, washed twice with DMF, twice with NMP and rinsed with IPA. A polymethacrylate (PMA) gel with pierced circles was placed on one side of the slide. Thirty microlitres of Fl-AA coupling solution (Table 7) was added in each well and then covered with aluminum foil to protect from light for two hours.

TABLE 7
Fl-AA Coupling Soln 0.1 M (FL/Gly/DIC)

| | | MW | d | molar | final | final | | | |
|---|---|---|---|---|---|---|---|---|---|
| REAGENTS | Source | (g/mol) | (g/ml) | ratio | conc (M) | vol (L) | moles | grams | mls |
| Carboxy-fluorescein | Aldrich | 376.32 | | 0.1 | 0.01 | 0.001 | 0.00001 | 0.0038 | |
| Boc-Gly-OH | Nova | 175.19 | | 0.9 | 0.09 | 0.001 | 0.00009 | 0.0158 | |
| HOBt | Aldrich | 135.13 | | 1 | 0.1 | 0.001 | 0.0001 | 0.0135 | |
| DIC | Aldrich | 126.2 | 0.815 | 1 | 0.1 | 0.001 | 0.0001 | 0.0126 | 0.0155 |
| NMP | Fluka | | | | | 0.001 | | | |

The Fl-AA coupling solution from wells was removed and the wells washed twice with NMP. The PMA gel was removed and the slide rinsed with NMP, IPA and ethanol. The slide was dipped into 50% EDA/EtOH for 30 min, washed twice with EtOH, 15 min each time. The slide was then rinsed with IPA and dry with N₂. Next, 1 drop of TE buffer, pH 8 was added and covered with a cover slip. The slide was scanned for fluorescence on a confocal microscope at 494 nm/525 nm (Ex/Em) and 0.4 gain. Images were processed with Scion software. Background substracted intensity should be ˜100.

### Synthesis Cycle

1. Boc deprotection & wash: Boc was removed by TFA or by PGA. For TFA Boc removal, the slide was treated with 100% TFA for 30 min and then washed with IPA 4 times and DMF once. For PGA Boc removal, the slide was placed on the spinner and washed with acetone and isopropanol, program 2 (2000 rpm, 30 sec). PAG solution (˜1 ml, Table 8) was added and spin coated as described in Example 2.

TABLE 8
PAG solution (10 g)

| Stock Sln | Source | Amount (g) | Final con (%) |
|---|---|---|---|
| 25% PMMA/PGMEA | Polysciences | 1 | 2.5 |
| Iodo-PAG | Aldrich | 1 | 10 |
| ITX | Aldrich | 1 | 10 |
| PGMEA | Aldrich | 7 | |

2. Neutralization & wash: The slide was neutralized with 5% DIEA/DMF for 5 min, then washed with DMF twice and NMP twice.

3. Coupling & capping: AA coupling solution (Table 6a or b) was added to the slide, for 60 min with shaking. The coupling solution was replaced with capping solution (25% Acetic anhydride/NMP) for 30 min with shaking.

4. Final wash: The capping solution was removed, the slide washed with NMP twice, IPA twice, and dried with N₂.

### Side Chain Deprotection

The peptide slide was treated with TFA for 15 min. The TFA was then replaced with side chain deprotection solution for 60 min with shaking.

TABLE 9
Side chain deprotection solution

| Reagents | Source | MW | d (g/ml) | g | ml |
|---|---|---|---|---|---|
| PMB | Aldrich | 148.25 | 0.917 | 0.0458 | 0.05 |
| Thioanisol | Aldrich | 124.21 | 1.058 | 0.0635 | 0.06 |
| 30% HBr/AcOH | Aldrich | | | | 0.4 |
| TFA | Aldrich | | | | 9.49 |

The deprotection solution was removed and the slide washed with IPA 4 times and then dried with N₂.

Prior to a bio-assay, the slide is neutralized with 5% DIEA as described above.

### Example 17

### Spin Coating and Exposure of Array

An array was spin coated and exposed by using a mask (EV620) or with micromirrors. Spin coating was performed as in Table 10. Exposure with a mask was performed as in Table 11, or with micromirrors as described in Table 12.

TABLE 10
Spin Coating

| Step | Description | Procedure |
|---|---|---|
| 1 | Cleaning | Spin substrate on program 2 |
| | | (2000 rpm for 30 seconds) |
| | | and spray with Acetone |
| 2 | Photoresist coating | Dispense photoresist on substrate |
| | | Close cover |
| | | Spin on program 4 |
| | | (2000 rpm for 60 seconds) |
| 3 | Softbake | 85° C. for 90 seconds |
| 4 | Exposure (EV, see | EV dose: 50 mJ/cm2 |
| | Table 8, or MM, see Table 9) | MM dose: 8 mJ/cm2 |
| 5 | Post Exposure Bake | 65° C. for 60 seconds |
| 6 | Photoresist stripping | Spin substrate on program 2 |
| | | (2000 rpm for 30 seconds) |
| | | and spray with Acetone |

TABLE 11
Exposure with Masks

| Step | Description | Procedure |
|---|---|---|
| 1 | Intensity check | Remove wafer chuck and replace with intensity measurement |
| | | plate |
| | | Make sure OAI meter is adjusted to 365 nm wavelength |
| | | Place glass plate (with or without transparency) on top of the |
| | | circular mask opening |
| | | Place intensity probe on center of plate |
| | | Select “Uniformity Measurement” under the pop-down menu, |
| | | and follow step-by-step instruction on screen |
| | | After taking note of intensity reading, click “continue” on the |
| | | screen, then Exit |
| | | Remove glass plate |
| | | Remove measurement plate and replace with wafer chuck |
| 2 | Mask loading | Place mask loading plate on top of wafer chuck |
| | | Place mask (or glass plate with transparency) on the mask plate |
| | | (press against the positioning pins) |
| | | Open the recipe file and enter the exposure time (Time = |
| | | Dose/Intensity) |
| | | Click on “Run” and follow step-by-step instruction on the |
| | | screen. |
| | | After mask is loaded, remove the mask loading plate from the |
| | | wafer chuck |
| 3 | Exposure | Follow instruction on screen after mask is loaded to expose |
| | | substrate |
| | | Click “Exit” to remove mask and exit the program |

TABLE 12
Exposure with Micromirrors

| Step | Description | Procedure |
|---|---|---|
| 1 | Intensity check | Make sure OAI meter is adjusted to 365 nm wavelength |
| | | Load the Bitmap file “Exposure Intensity Check” on the |
| | | computer screen |
| | | Place the intensity probe underneath the exposure field (use |
| | | sensor #1) |
| | | Press the Expose button and note the intensity reading |
| 2 | Substrate alignment and exposure | Set the desired exposure time (Time = Dose/Intensity) |
| | | Place substrate on vacuum chuck (press against the top left |
| | | hand corner) and turn on vacuum switch |
| | | Run the Labview program |
| | | Using the stage controller and the rotational stage knob, align |
| | | the crosshairs (or left corner and right edge) on the substrate to |
| | | line up with the crosshairs on the Labview display |
| | | Reset the X and Y coordinates on the remote display to zero |
| | | (press “UP” until “Clear All Axis Position” is displayed and |
| | | press “PGM” |
| | | On the computer display, switch from Labview program to |
| | | desired Bitmap artwork |
| | | Using the stage controller, move the stage to the correct X and |
| | | Y locations, then press the Expose button, repeat as necessary |

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1-126. (canceled)

127. A peptide array comprising: a plurality of peptides coupled to a support; wherein at least a set of said peptides are random peptides that are differ from each other by one monomer at least at one position in said set; wherein said array comprises one or more of the following elements:
(a) at least 100 of said different peptides;
(b) each of said different peptides is located within a feature with an area of up to 50 um²; or
(c) each of said different peptides has at least 5 monomers.

128. A peptide array comprising: a plurality of peptides coupled to a support; wherein at least a set of said peptides represent sequences from at least 10%, 50%, 90%, or all of a proteome of an organ or organism in said set; wherein said array comprises one or more of the following elements:
(a) at least 100 of said different peptides;
(b) each of said different peptides is located within a feature with an area of up to 50 um²; or
(c) each of said different peptides has at least 5 monomers.

129. A peptide array comprising: a plurality of peptides coupled to a support, wherein a set of said peptides has sequences from viral proteins or proteome or the proteome of a class or family of virus or proteome of all viruses, wherein the array has one or more of the following elements:
(a) at least 100 different peptides;
(b) each of the peptides is within a feature with an area up to 50 um²; and
(c) each of the peptides has at least 5 monomers.

130. A method of testing protein-protein interaction comprising using the peptide array of any one of claims 127-129 to test a protein protein interaction.

131. The method of claim 130, wherein said protein-protein interaction is antibody and antigen binding, epitope binding, receptor and ligand binding, or domain and domain binding within a protein or between proteins.

132. The method of claim 130, wherein a biological sample is applied to said array.

133. The method of claim 132, wherein said biological sample comprises a recombinant protein, a protein purified from an endogenous source, or a mixture of proteins in a cell lysate, tissue sample, or sample from bacteria, yeast, animals, or humans.

134. The method of claim 133, wherein said cell or tissue sample is animal or human cell or tissue that is or is not diseased.

135. The method of claim 133, wherein said cell or tissue is blood or serum or other bodily fluid from healthy or diseased animal or human.

136. The method of claim 132, wherein said binding is used to diagnose a disease condition, or predict a response to therapeutic treatment, or select a candidate agent for therapeutic development, or stratify patients for therapeutic testing, or used as guidelines for treatment decisions.

137. The method of claim 136, wherein said disease in is cancer, an autoimmune disease, an inflammatory disease, a neurodegenerative disease, a metabolic disease, a transplant rejection, or cardiovascular disease.

138. The method of claim 136, wherein said therapeutics are small chemical therapeutics, or biological therapeutics including protein therapeutics or antibody therapeutics or vaccines.

139. A method for screening a plurality of peptides as potential drug candidates comprising applying a drug target to any one of the peptide arrays of claims 127-129 and detecting binding of the drug target to one or more peptides on the array.

140. The method of claim 139, wherein if a peptide binds a drug target, the peptide is further screened by testing whether the peptide affects the activity of the drug target.

141. A method for screening a plurality of peptides as potential drug candidates comprising applying one or more drug targets to any one of the peptide arrays of claims 127-129 and analyzing for modification of one or more peptides by the target.

142. A method of screening a plurality of small chemical compounds comprising applying one or more of said chemical compounds to any one of the peptide arrays of claims 127-129 and measuring the binding of the one or more small chemical compounds to one or more peptides on the array.
